(19) United States
(12) Patent Application Publication
(10) Pub. No.: US 2016/0252708 A1
(43) Pub. Date: Sep. 1, 2016

(54) OPTICAL IMAGING LENS

(71) Applicant: GLORY SCIENCE CO., LTD., Changhua Hsien (TW)

(72) Inventors: Feng-Chao CHUNG, Changhua Hsien (TW); Kun-Ti LIU, Changhua Hsien (TW)

(73) Assignee: GLORY SCIENCE CO., LTD.

(21) Appl. No.: 14/634,242

(22) Filed: Feb. 27, 2015

(51) Int. Cl. G02B 13/00; G02B 9/60

(52) U.S. Cl. CPC G02B 13/0045; G02B 9/60

(57) ABSTRACT

An optical imaging lens includes an aperture stop and an optical assembly, the optical assembly includes, in order from the object side to the image side: a first lens element with a positive refractive power; a second lens element with a negative refractive power; a third lens element with a positive refractive power; a fourth lens element with a positive refractive power; a fifth lens element with a negative refractive power; wherein focal lengths of the optical imaging lens, first, second, third, fourth and fifth lens elements are f, f1, f2, f3, f4, f5, respectively, radii of curvature of object-side and image-side surfaces of the fifth lens element are R9, R10, respectively, and the following conditions are satisfied: |f5|<|fn|, n=1, 2, 3, 4; −0.45<f5/f<−0.2; 0<(R9+R10)/(R9−R10)<0.5.

### BACKGROUND OF THE INVENTION

1. Field of the Invention

The present invention relates to an optical lens system, and more particularly to a miniaturized optical imaging lens applicable to electronic products.

2. Description of the Prior Art

Currently, small imaging lens with high image quality has become the standard equipment for mobile devices. In addition, as the advanced semiconductor manufacturing technologies have allowed the pixel size of image sensors to be reduced and compact, there's an increasing demand for imaging lens featuring finer resolution and better image quality.

A conventional imaging lens used in mobile devices, such as, mobile phone, tablet computer and other wearable electronic devices, usually consists of three to four lens elements: such as the imaging lenses described in U.S. Pat. Nos. 7,564,635 and 7,920,340, which cannot obtain better image quality. The imaging lenses consisting of five lens elements disclosed in U.S. Pat. Nos. 8,605,368, 8,649,113 and TW Appl. Nos. 102137030 and 102121155 have better image quality, however, the sensitivity problem during manufacturing and assembling processes is often existed while having a large aperture value, increasing the production cost. Or the peripheral image quality will be reduced while reducing the assembly tolerance, causing the peripheral imaging vague or deformed.

The present invention has been made in order to solve the above-mentioned problems.

### SUMMARY OF THE INVENTION

The primary objective of the present invention is to provide an optical imaging lens having high image quality, high resolution, low distortion and low sensitivity to assembly.

According to one aspect of the present invention, an optical imaging lens comprises an aperture stop and an optical assembly, the optical assembly comprises, in order from the object side to the image side: a first lens element with a positive refractive power having an aspheric object-side surface being convex near the optical axis and an aspheric image-side surface, the first lens element being made of plastic material; a second lens element with a negative refractive power having an aspheric object-side surface being convex near the optical axis and an aspheric image-side surface being concave near the optical axis, the second lens element being made of plastic material; a third lens element with a positive refractive power having an aspheric object-side surface being convex near the optical axis and an aspheric image-side surface, the third lens element being made of plastic material; a fourth lens element with a positive refractive power having an aspheric object-side surface being concave near the optical axis and an aspheric image-side surface being convex near the optical axis, the fourth lens element being made of plastic material; a fifth lens element with a negative refractive power having an aspheric object-side surface being concave near the optical axis and an aspheric image-side surface being concave near the optical axis, the fifth lens element being made of plastic material, at least one inflection point being formed on the object-side surface and the image-side surface of the fifth lens element; and the aperture stop being located between the image-side surface of the first lens element and an object to be photographed.

Wherein the focal length of the optical imaging lens is f, the focal length of the first lens element is f1, the focal length of the second lens element is f2, the focal length of the third lens element is f3, the focal length of the fourth lens element is f4, the focal length of the fifth lens element is f5, the radius of curvature of the object-side surface of the fifth lens element is R9, the radius of curvature of the image-side surface of the fifth lens element is R10, and the following conditions are satisfied:

|f5|<|fn|, wherein n=1,2,3 and 4;

−0.45<f5/f<−0.2;

0<(R9+R10)/(R9−R10)<0.5.

If |f5|≦|fn| satisfies the above condition, the refractive power of the first, second, third and fourth lens elements can be distributed evenly, which can balance the aberrations caused by the optical imaging lens and obtain better image quality. In addition, the sensitivity to assembly of the first, second, third and fourth lens elements can also be reduced, which can reduce the production cost.

If f5/f satisfies the above condition, the refractive power of the fifth lens element can be maintained in the appropriate range, which can reduce the sensitivity to assembly of the fifth lens element. In addition, it can maintain a sufficient back focal length of the optical imaging lens for placing the IR cut filter and assembling the electronic sensor.

If (R9+R10)/(R9−R10) satisfies the above condition, the shape of the fifth lens element can be controlled, which will be favorable to control the ghost phenomenon of the object-side surface and the image-side surface of the fifth lens element caused by internal reflection while providing aspheric surfaces.

Preferably, the focal length of the optical imaging lens is f, the focal length of the first lens element is f1, and the following condition is satisfied: 0.7<f1/f<0.81, so that the refractive power of the first lens element can be maintained in the appropriate range, and the maximal field of view (FOV) of the optical imaging lens can be maintained in the appropriate angle, which can reduce the sensitivity to assembly of the first lens element.

Preferably, the focal length of the optical imaging lens is f, the focal length of the second lens element is f2, and the following condition is satisfied: −1.5<f2/f<−1, so that the refractive power of the second lens element can be maintained in the appropriate range, which can reduce the sensitivity to assembly of the second lens element.

Preferably, the radius of curvature of the object-side surface of the second lens element is R3, the radius of curvature of the image-side surface of the second lens element is R4, and the following condition is satisfied: 0.5<(R3−R4)/(R3+R4)<0.85, it can reduce the spherical aberration and astigmatism of the optical imaging lens effectively.

Preferably, the distance along the optical axis between the aperture stop and the image-side surface of the fifth lens element is SD, the distance along the optical axis between the object-side surface of the first lens element and the image-side surface of the fifth lens element is TD, and the following condition is satisfied: 0.89<SD/TD<1.05, it can make the chief ray angle with respect to the image plane of the optical imaging lens cooperated with the electronic sensor, so as to avoid causing color shift as well as the dark corner phenomenon.

Preferably, the central thickness of the second lens element is CT2, the central thickness of the third lens element is CT3, and the following condition is satisfied: 2<CT3/CT2<3.5, it can control the thicknesses of the second and third lens elements effectively, so as to make the injection molding easier.

Preferably, the focal length of the optical imaging lens is f, the focal length of the third lens element is f3, and the following condition is satisfied: 4.5<f3/f<12, so that the refractive power of the third lens element can be maintained in the appropriate range, which can reduce the sensitivity to assembly of the third lens element.

Preferably, the focal length of the optical imaging lens is f, the focal length of the fourth lens element is f4, and the following condition is satisfied: 0.25<f4/f<0.6, so that the refractive power of the fourth lens element can be maintained in the appropriate range, and the refractive power of the fifth lens element can be dispersed reasonably, which can reduce the sensitivity to assembly of the fourth and fifth lens elements.

Preferably, the distance along the optical axis between the second lens element and the third lens element is T23, the distance along the optical axis between the third lens element and the fourth lens element is T34, and the following condition is satisfied: 0.6<T23/T34≦1, it can reduce the total track length of the optical imaging lens effectively.

Preferably, the Abbe number of the first lens element is V1, the Abbe number of the second lens element is V2, the Abbe number of the third lens element is V3, the Abbe number of the fourth lens element is V4, the Abbe number of the fifth lens element is V5, and the following condition is satisfied: −40<V2−Vn<−25, wherein n=1, 3, 4 and 5, which can reduce the chromatic aberration of the optical imaging lens effectively.

According to another aspect of the present invention, an optical imaging lens comprises an aperture stop and an optical assembly, the optical assembly comprises, in order from the object side to the image side: a first lens element with a positive refractive power having an aspheric object-side surface being convex near the optical axis and an aspheric image-side surface; a second lens element with a negative refractive power having an aspheric object-side surface being convex near the optical axis and an aspheric image-side surface being concave near the optical axis, the second lens element being made of plastic material; a third lens element with a positive refractive power having an aspheric object-side surface being convex near the optical axis and an aspheric image-side surface, the third lens element being made of plastic material; a fourth lens element with a positive refractive power having an aspheric object-side surface and an aspheric image-side surface being convex near the optical axis, the fourth lens element being made of plastic material; a fifth lens element with a negative refractive power having an aspheric object-side surface being concave near the optical axis and an aspheric image-side surface being concave near the optical axis, the fifth lens element being made of plastic material, at least one inflection point being formed on the object-side surface and the image-side surface of the fifth lens element; and the aperture stop being located between the image-side surface of the first lens element and an object to be photographed.

Wherein the focal length of the optical imaging lens is f, the focal length of the first lens element is f1, the focal length of the second lens element is f2, the focal length of the third lens element is f3, the focal length of the fourth lens element is f4, the focal length of the fifth lens element is f5, the radius of curvature of the object-side surface of the second lens element is R3, the radius of curvature of the image-side surface of the second lens element is R4, and the following conditions are satisfied:

|f5|<|f4|<|fn|, wherein n=1,2 and 3;

0.5<(R3−R4)/(R3+R4)<0.85.

If |f5|<|f4|<|fn| satisfies the above condition, the refractive power of the first, second, third and fourth lens elements can be distributed evenly, which can balance the aberrations caused by the optical imaging lens and obtain better image quality. In addition, the sensitivity to assembly of the first, second, third and fourth lens elements can also be reduced, which can reduce the production cost.

If (R3−R4)/(R3+R4) satisfies the above condition, the spherical aberration and astigmatism of the optical imaging lens can be reduced effectively.

Preferably, the focal length of the optical imaging lens is f, the focal length of the first lens element is f1, and the following condition is satisfied: 0.7<f1/f<0.81, so that the refractive power of the first lens element can be maintained in the appropriate range, and the maximal field of view (FOV) of the optical imaging lens can be maintained in the appropriate angle, which can reduce the sensitivity to assembly of the first lens element.

Preferably, the focal length of the optical imaging lens is f, the focal length of the fifth lens element is f5, and the following condition is satisfied: −0.45<f5/f<−0.2, so that the refractive power of the fifth lens element can be maintained in the appropriate range, which can reduce the sensitivity to assembly of the fifth lens element. In addition, it can maintain a sufficient back focal length of the optical imaging lens for placing the IR cut filter and assembling the electronic sensor.

Preferably, the distance along the optical axis between the aperture stop and the image-side surface of the fifth lens element is SD, the distance along the optical axis between the object-side surface of the first lens element and the image-side surface of the fifth lens element is TD, and the following condition is satisfied: 0.89<SD/TD<1.05, it can make the chief ray angle with respect to the image plane of the optical imaging lens cooperated with the electronic sensor, so as to avoid causing color shift as well as the dark corner phenomenon.

Preferably, the central thickness of the third lens element is CT3, the central thickness of the fourth lens element is CT4, and the following condition is satisfied: 1<CT4/CT3<1.4, so that the thicknesses of the third and fourth lens elements will be more proper, which can make the injection molding easier.

Preferably, the Abbe number of the first lens element is V1, the Abbe number of the second lens element is V2, the Abbe number of the third lens element is V3, the Abbe number of the fourth lens element is V4, the Abbe number of the fifth lens element is V5, and the following condition is satisfied: −40<V2−Vn<−25, wherein n=1, 3, 4 and 5, which can reduce the chromatic aberration of the optical imaging lens effectively.

Preferably, the radius of curvature of the object-side surface of the fifth lens element is R9, the radius of curvature of the image-side surface of the fifth lens element is R10, and the following condition is satisfied: 0<(R9+R10)/(R9−R10)<0.5, so that the shape of the fifth lens element can be controlled, which will be favorable to control the ghost phenomenon of the object-side surface and the image-side surface of the fifth lens element caused by internal reflection while providing aspheric surfaces.

Preferably, the focal length of the optical imaging lens is f, the focal length of the fourth lens element is f4, and the following condition is satisfied: 0.25<f4/f<0.6, so that the refractive power of the fourth lens element can be maintained in the appropriate range, and the refractive power of the fifth lens element can be dispersed reasonably, which can reduce the sensitivity to assembly of the fourth and fifth lens elements.

Preferably, the maximal field of view of the optical imaging lens is FOV, and the following condition is satisfied: 72<FOV<84, which can maintain a suitable larger field of view of the optical imaging lens.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows an optical imaging lens in accordance with a first embodiment of the present invention;

FIG. 1B shows the longitudinal spherical aberration curve, the astigmatic field curve and the distortion curve of the first embodiment of the present invention;

FIG. 2A shows an optical imaging lens in accordance with a second embodiment of the present invention;

FIG. 2B shows the longitudinal spherical aberration curve, the astigmatic field curve and the distortion curve of the second embodiment of the present invention;

FIG. 3A shows an optical imaging lens in accordance with a third embodiment of the present invention;

FIG. 3B shows the longitudinal spherical aberration curve, the astigmatic field curve and the distortion curve of the third embodiment of the present invention;

FIG. 4A shows an optical imaging lens in accordance with a fourth embodiment of the present invention;

FIG. 4B shows the longitudinal spherical aberration curve, the astigmatic field curve and the distortion curve of the fourth embodiment of the present invention;

FIG. 5A shows an optical imaging lens in accordance with a fifth embodiment of the present invention;

FIG. 5B shows the longitudinal spherical aberration curve, the astigmatic field curve and the distortion curve of the fifth embodiment of the present invention;

FIG. 6A shows an optical imaging lens in accordance with a sixth embodiment of the present invention;

FIG. 6B shows the longitudinal spherical aberration curve, the astigmatic field curve and the distortion curve of the sixth embodiment of the present invention;

FIG. 7A shows an optical imaging lens in accordance with a seventh embodiment of the present invention;

FIG. 7B shows the longitudinal spherical aberration curve, the astigmatic field curve and the distortion curve of the seventh embodiment of the present invention;

FIG. 8A shows an optical imaging lens in accordance with an eighth embodiment of the present invention; and

FIG. 8B shows the longitudinal spherical aberration curve, the astigmatic field curve and the distortion curve of the eighth embodiment of the present invention.

### DETAILED DESCRIPTION OF THE PREFERRED EMBODIMENTS

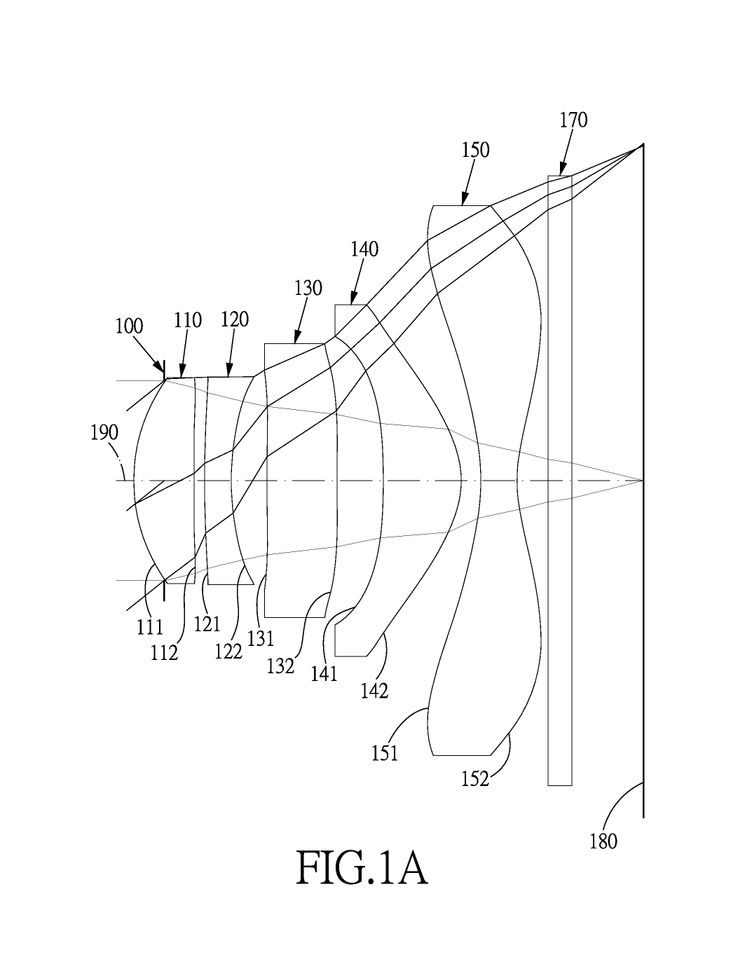

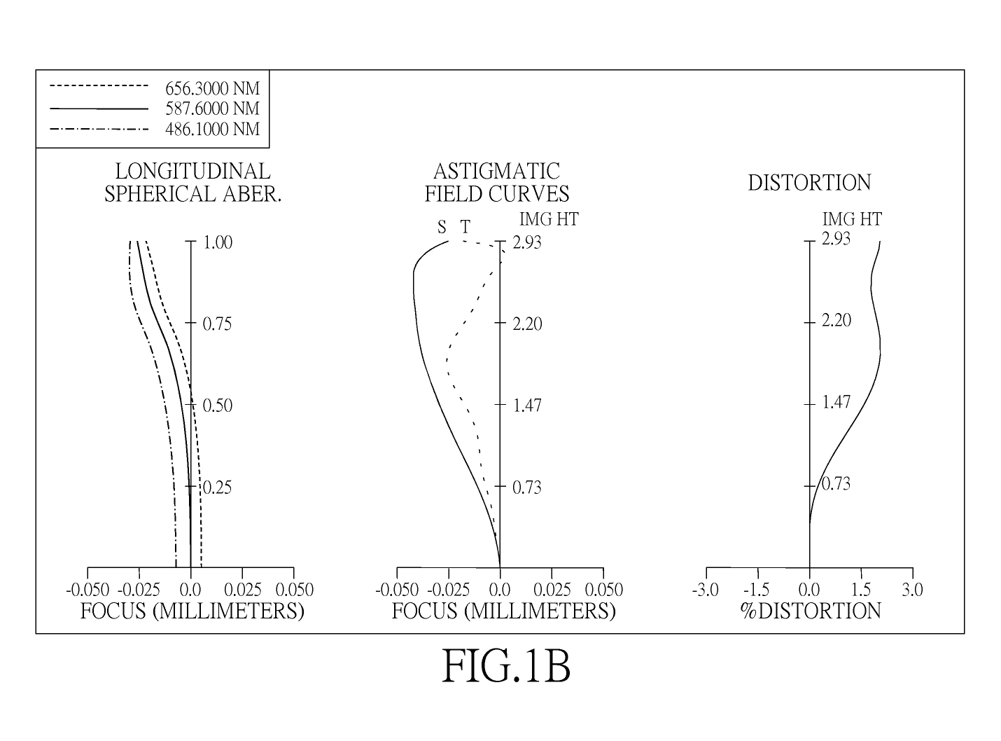

FIG. 1A shows an optical imaging lens in accordance with a first embodiment of the present invention, and FIG. 1B shows, in order from left to right, the longitudinal spherical aberration curves, the astigmatic field curves, and the distortion curve of the first embodiment of the present invention. An optical imaging lens in accordance with the first embodiment of the present invention comprises an aperture stop 100 and an optical assembly. The optical assembly comprises, in order from an object side to an image side: a first lens element 110, a second lens element 120, a third lens element 130, a fourth lens element 140, a fifth lens element 150, an IR cut filter 170 and an image plane 180, wherein the optical imaging lens has a total of five lens elements with refractive power. The aperture stop 100 is located between an image-side surface 112 of the first lens element 110 and an object to be photographed.

The first lens element 110 with a positive refractive power has an object-side surface 111 being convex near an optical axis 190 and the image-side surface 112 being concave near the optical axis 190, both the object-side and image-side surfaces 111, 112 are aspheric, and the first lens element 110 is made of plastic material.

The second lens element 120 with a negative refractive power has an object-side surface 121 being convex near the optical axis 190 and an image-side surface 122 being concave near the optical axis 190, both the object-side and image-side surfaces 121, 122 are aspheric, and the second lens element 120 is made of plastic material.

The third lens element 130 with a positive refractive power has an object-side surface 131 being convex near the optical axis 190 and an image-side surface 132 being concave near the optical axis 190, both the object-side and image-side surfaces 131, 132 are aspheric, the third lens element 130 is made of plastic material.

The fourth lens element 140 with a positive refractive power has an object-side surface 141 being concave near the optical axis 190 and an image-side surface 142 being convex near the optical axis 190, both the object-side and image-side surfaces 141, 142 are aspheric, the fourth lens element 140 is made of plastic material.

The fifth lens element 150 with a negative refractive power has an object-side surface 151 being concave near the optical axis 190 and an image-side surface 152 being concave near the optical axis 190, both the object-side and image-side surfaces 151, 152 are aspheric, the fifth lens element 150 is made of plastic material, and at least one inflection point is formed on the object-side surface 151 and the image-side surface 152 of the fifth lens element 150.

The IR cut filter 170 made of glass is located between the fifth lens element 150 and the image plane 180 and has no influence on the focal length of the optical imaging lens.

The equation for the aspheric surface profiles of the first embodiment is expressed as follows:

$$z ( h ) = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + …$$

z represents the distance of a point on the aspheric surface at a height h from the optical axis 190 relative to a plane perpendicular to the optical axis at the vertex of the aspheric surface;

c is a paraxial curvature equal to 1/R (R: a paraxial radius of curvature);

h represents a vertical distance from the point on the curve of the aspheric surface to the optical axis 190;

k represents the conic constant;

A₄, A₆, A₈, A₁₀, A₁₂, A₁₄ . . . : represent the high-order aspheric coefficients.

In the first embodiment of the present optical imaging lens, the focal length of the optical imaging lens is f, the f-number of the optical imaging lens is Fno, half of the maximal field of view of the optical imaging lens is HFOV, and the following conditions are satisfied:

f=3.66 mm, Fno=2.1, and HFOV=38.2 degrees.

In the first embodiment of the present optical imaging lens, the focal length of the first lens element 110 is f1, the focal length of the second lens element 120 is f2, the focal length of the third lens element 130 is f3, the focal length of the fourth lens element 140 is f4, the focal length of the fifth lens element 150 is f5, and the following conditions are satisfied:

|f5|<|fn|, wherein n=1,2,3 and 4;

|f5|<|f4|<|fn|, wherein n=1,2 and 3.

In the first embodiment of the present optical imaging lens, the focal length of the optical imaging lens is f, the focal length of the fifth lens element 150 is f5, and the following condition is satisfied:

f5/f=−0.36.

In the first embodiment of the present optical imaging lens, the radius of curvature of the object-side surface 151 of the fifth lens element 150 is R9, the radius of curvature of the image-side surface 152 of the fifth lens element 150 is R10, and the following condition is satisfied:

(R9+R10)/(R9−R10)=0.16.

In the first embodiment of the present optical imaging lens, the focal length of the optical imaging lens is f, the focal length of the first lens element 110 is f1, and the following condition is satisfied:

f1/f=0.77.

In the first embodiment of the present optical imaging lens, the focal length of the optical imaging lens is f, the focal length of the second lens element 120 is f2, and the following condition is satisfied:

f2/f=−1.34.

In the first embodiment of the present optical imaging lens, the radius of curvature of the object-side surface 121 of the second lens element 120 is R3, the radius of curvature of the image-side surface 122 of the second lens element 120 is R4, and the following condition is satisfied:

(R3−R4)/(R3+R4)=0.62.

In the first embodiment of the present optical imaging lens, the distance along the optical axis 190 between the aperture stop 100 and the image-side surface 152 of the fifth lens element 150 is SD, the distance along the optical axis 190 between the object-side surface 111 of the first lens element 110 and the image-side surface 152 of the fifth lens element 150 is TD, and the following condition is satisfied:

SD/TD=0.92.

In the first embodiment of the present optical imaging lens, the central thickness of the second lens element 120 is CT2, the central thickness of the third lens element 130 is CT3, and the following condition is satisfied:

CT3/CT2=2.62.

In the first embodiment of the present optical imaging lens, the focal length of the optical imaging lens is f, the focal length of the third lens element 130 is f3, and the following condition is satisfied:

f3/f=7.00.

In the first embodiment of the present optical imaging lens, the focal length of the optical imaging lens is f, the focal length of the fourth lens element 140 is f4, and the following condition is satisfied:

f4/f=0.42.

In the first embodiment of the present optical imaging lens, the distance along the optical axis 190 between the second lens element 120 and the third lens element 130 is T23, the distance along the optical axis 190 between the third lens element 130 and the fourth lens element 140 is T34, and the following condition is satisfied:

T23/T34=0.77.

In the first embodiment of the present optical imaging lens, the maximal field of view of the optical imaging lens is FOV, and the following condition is satisfied:

FOV=76.42.

In the first embodiment of the present optical imaging lens, the central thickness of the third lens element 130 is CT3, the central thickness of the fourth lens element 140 is CT4, and the following condition is satisfied:

CT4/CT3=1.11.

In the first embodiment of the present optical imaging lens, the Abbe number of the first lens element 110 is V1, the Abbe number of the second lens element 120 is V2, the Abbe number of the third lens element 130 is V3, the Abbe number of the fourth lens element 140 is V4, the Abbe number of the fifth lens element 150 is V5, and the following condition is satisfied:

V2−Vn=−33.90, wherein n=1,3,4 and 5.

The detailed optical data of the first embodiment is shown in Table 1, and the aspheric surface data is shown in Table 2.

TABLE 1
(Embodiment 1)
f(focal length) = 3.66 mm, Fno = 2.1, HFOV = 38.21 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | Aperture | Plane | −0.27 | | | | |
| | stop | | | | | | |
| 2 | Lens 1 | 1.52(ASP) | 0.53 | Plastic | 1.544 | 55.9 | 2.83 |
| 3 | | 91.23(ASP) | 0.09 | | | | |
| 4 | Lens 2 | 10.30(ASP) | 0.24 | Plastic | 1.642 | 22.0 | −4.91 |
| 5 | | 2.39(ASP) | 0.31 | | | | |
| 6 | Lens 3 | 11.77(ASP) | 0.62 | Plastic | 1.544 | 55.9 | 25.62 |
| 7 | | 74.31(ASP) | 0.41 | | | | |
| 8 | Lens 4 | −7.07(ASP) | 0.69 | Plastic | 1.544 | 55.9 | 1.52 |
| 9 | | −0.77(ASP) | 0.17 | | | | |
| 10 | Lens 5 | −1.78(ASP) | 0.32 | Plastic | 1.544 | 55.9 | −1.33 |
| 11 | | 1.29(ASP) | 0.27 | | | | |
| 12 | IR-filter | Plane | 0.21 | Glass | 1.517 | 64.2 | — |
| 13 | | Plane | 0.63 | | | | |
| 14 | Image | Plane | 0.00 | | | | |

Note:
Reference wavelength is 587.6 nm

TABLE 2
Aspheric Coefficients

| | Surface # | | | | |
|---|---|---|---|---|---|
| | 2 | 3 | 4 | 5 | 6 |
| k = | 7.0247E−02 | 9.0000E+01 | −1.4158E+01 | −1.0077E+01 | −8.6595E+01 |
| A4 = | 2.6158E−03 | 2.3471E−02 | −1.7998E−02 | 6.1910E−02 | −7.3137E−02 |
| A6 = | 5.1909E−03 | 2.0935E−03 | 6.2982E−02 | 3.0472E−02 | 1.5054E−03 |
| A8 = | −9.1543E−03 | −2.2702E−02 | −6.1198E−02 | 1.2351E−02 | −5.0048E−03 |
| A10 = | 1.2104E−02 | −1.5718E−02 | −3.1628E−02 | −1.8305E−02 | 6.5802E−03 |
| A12 = | 7.4126E−03 | −1.2860E−02 | 1.0467E−02 | −1.2189E−02 | 1.1668E−02 |
| A14 = | −2.8664E−02 | 2.3346E−04 | 2.3818E−02 | 4.9779E−02 | −5.4525E−03 |
| | Surface # | | | | |
| | 7 | 8 | 9 | 10 | 11 |
| k = | −9.0000E+01 | 2.9590E+01 | −3.6224E+00 | −1.8149E+01 | −1.1054E+01 |
| A4 = | −7.6402E−02 | −1.3150E−01 | −1.1700E−01 | −2.6410E−02 | −4.1846E−02 |
| A6 = | 2.5214E−02 | 5.4271E−02 | 5.9223E−02 | 5.3415E−03 | 7.4483E−03 |
| A8 = | −2.4450E−02 | 7.1943E−03 | −2.6392E−03 | 3.5616E−04 | −1.3015E−03 |
| A10 = | −1.0561E−04 | −2.0193E−02 | −2.2045E−03 | −6.4070E−05 | 4.8144E−05 |
| A12 = | 1.5153E−03 | −3.3044E−03 | −1.4156E−04 | −1.0907E−05 | 4.3034E−06 |
| A14 = | 4.3744E−03 | 3.5718E−03 | 4.0197E−06 | 1.5928E−06 | 2.7953E−07 |

The units of the radius of curvature, the thickness and the focal length in table 1 are expressed in mm, in the tables 1 and 2, the surface numbers 0-14 represent the surfaces sequentially arranged from the object-side to the image-side along the optical axis, and in table 2, k represents the conic coefficient of the equation of the aspheric surface profiles, and A₄, A₆, A₈, A₁₀, A₁₂, A₁₄ . . . : represent the high-order aspheric coefficients arranging from the 4th order to the 14th order. The tables presented below for each embodiment are the corresponding schematic parameter and aberration curves, and the definitions of the tables are the same as Table 1 and Table 2 of the first embodiment. Therefore, an explanation in this regard will not be provided again.

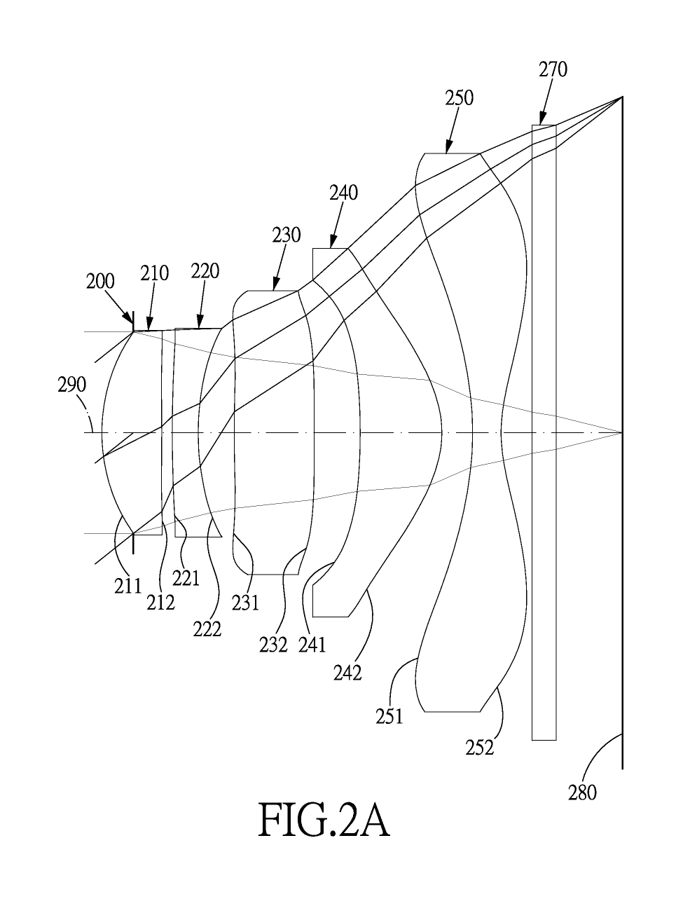

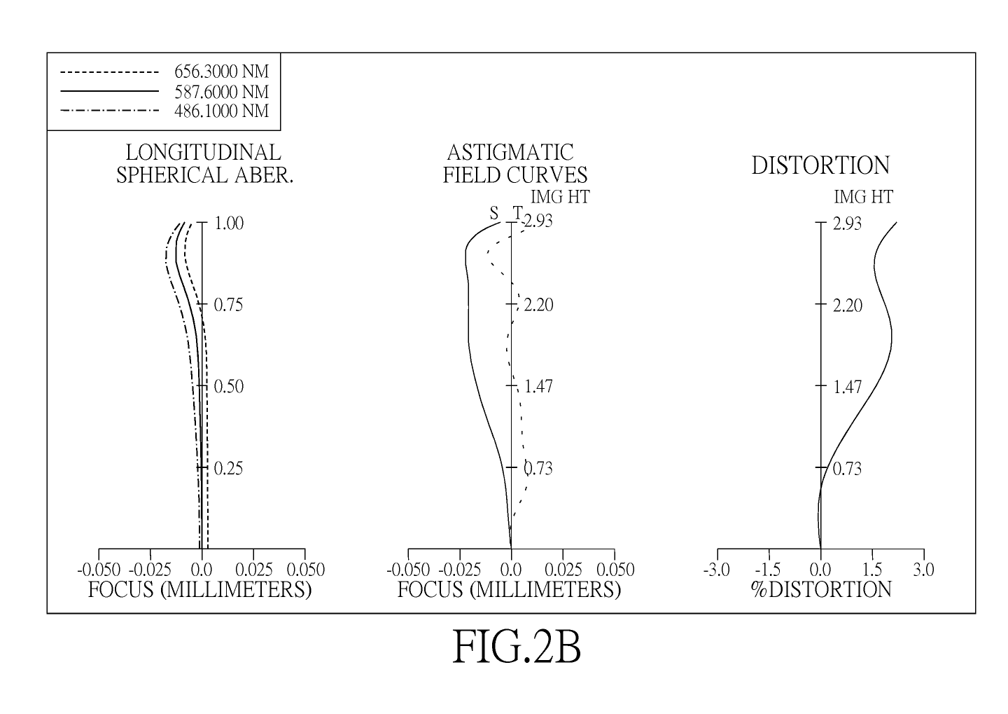

FIG. 2A shows an optical imaging lens in accordance with a second embodiment of the present invention, and FIG. 2B shows, in order from left to right, the longitudinal spherical aberration curves, the astigmatic field curves, and the distortion curve of the second embodiment of the present invention. An optical imaging lens in accordance with the second embodiment of the present invention comprises an aperture stop 200 and an optical assembly. The optical assembly comprises, in order from an object side to an image side: a first lens element 210, a second lens element 220, a third lens element 230, a fourth lens element 240, a fifth lens element 250, an IR cut filter 270 and an image plane 280, wherein the optical imaging lens has a total of five lens elements with refractive power. The aperture stop 200 is located between an image-side surface 212 of the first lens element 210 and an object to be photographed.

The first lens element 210 with a positive refractive power has an object-side surface 211 being convex near an optical axis 290 and the image-side surface 212 being convex near the optical axis 290, both the object-side and image-side surfaces 211, 212 are aspheric, and the first lens element 210 is made of plastic material.

The second lens element 220 with a negative refractive power has an object-side surface 221 being convex near the optical axis 290 and an image-side surface 222 being concave near the optical axis 290, both the object-side and image-side surfaces 221, 222 are aspheric, and the second lens element 220 is made of plastic material.

The third lens element 230 with a positive refractive power has an object-side surface 231 being convex near the optical axis 290 and an image-side surface 232 being concave near the optical axis 290, both the object-side and image-side surfaces 231, 232 are aspheric, the third lens element 230 is made of plastic material.

The fourth lens element 240 with a positive refractive power has an object-side surface 241 being concave near the optical axis 290 and an image-side surface 242 being convex near the optical axis 290, both the object-side and image-side surfaces 241, 242 are aspheric, the fourth lens element 240 is made of plastic material.

The fifth lens element 250 with a negative refractive power has an object-side surface 251 being concave near the optical axis 290 and an image-side surface 252 being concave near the optical axis 290, both the object-side and image-side surfaces 251, 252 are aspheric, the fifth lens element 250 is made of plastic material, and at least one inflection point is formed on the object-side surface 251 and the image-side surface 252 of the fifth lens element 250.

The IR cut filter 270 made of glass is located between the fifth lens element 250 and the image plane 280 and has no influence on the focal length of the optical imaging lens.

The detailed optical data of the second embodiment is shown in Table 3 and the aspheric surface data is shown in Table 4 below.

TABLE 3
(Embodiment 2)
f(focal length) = 3.67 mm, Fno = 2.09, HFOV = 38.0 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | Aperture | Plane | −0.28 | | | | |
| | stop | | | | | | |
| 2 | Lens 1 | 1.56(ASP) | 0.53 | Plastic | 1.544 | 55.9 | 2.75 |
| 3 | | −34.73(ASP) | 0.09 | | | | |
| 4 | Lens 2 | 14.06(ASP) | 0.23 | Plastic | 1.642 | 22.0 | −4.26 |
| 5 | | 2.27(ASP) | 0.32 | | | | |
| 6 | Lens 3 | 9.69(ASP) | 0.71 | Plastic | 1.544 | 55.9 | 20.20 |
| 7 | | 80.00(ASP) | 0.41 | | | | |
| 8 | Lens 4 | −7.40(ASP) | 0.72 | Plastic | 1.544 | 55.9 | 1.78 |
| 9 | | −0.89(ASP) | 0.27 | | | | |
| 10 | Lens 5 | −2.71(ASP) | 0.25 | Plastic | 1.544 | 55.9 | −1.54 |
| 11 | | 1.25(ASP) | 0.27 | | | | |
| 12 | IR-filter | Plane | 0.21 | Glass | 1.517 | 64.2 | — |
| 13 | | Plane | 0.59 | | | | |
| 14 | Image | Plane | 0.00 | | | | |

Note:
Reference wavelength is 587.6 nm

TABLE 4
Aspheric Coefficients

| | Surface # | | | | |
|---|---|---|---|---|---|
| | 2 | 3 | 4 | 5 | 6 |
| k = | 1.2198E−01 | −9.0000E+01 | −1.7421E+01 | −1.0120E+01 | −8.0630E+01 |
| A4 = | 2.9351E−03 | 4.1898E−02 | −8.0908E−03 | 6.1871E−02 | −8.0276E−02 |
| A6 = | 7.7856E−03 | 5.8550E−03 | 7.1233E−02 | 3.9633E−02 | 2.5090E−02 |
| A8 = | −1.0733E−02 | −1.4097E−02 | −5.6515E−02 | 3.3650E−03 | −2.6294E−02 |
| A10 = | 1.3405E−02 | −1.6620E−02 | −4.4089E−02 | −1.7486E−02 | −4.4264E−03 |
| A12 = | 1.8268E−02 | −1.4108E−02 | −2.5249E−04 | −2.0727E−02 | 3.4637E−02 |
| A14 = | −2.9283E−02 | 2.3849E−04 | 2.4333E−02 | 5.0853E−02 | −5.5702E−03 |
| | Surface # | | | | |
| | 7 | 8 | 9 | 10 | 11 |
| k = | −9.0000E+01 | 2.7780E+01 | −3.7305E+00 | −1.5107E+01 | −1.0741E+01 |
| A4 = | −7.6560E−02 | −1.0281E−01 | −1.1270E−01 | −2.8902E−02 | −3.8799E−02 |
| A6 = | 2.2129E−02 | 4.0435E−02 | 5.9922E−02 | 5.2847E−03 | 7.1127E−03 |
| A8 = | −2.3326E−02 | 9.4245E−03 | −4.5633E−03 | 3.2008E−04 | −1.3180E−03 |
| A10 = | −5.6377E−04 | −1.8708E−02 | −2.1333E−03 | −5.9013E−05 | 5.1730E−05 |
| A12 = | −3.5958E−04 | −3.1895E−03 | 1.2506E−04 | −9.3147E−06 | 4.7693E−06 |
| A14 = | 4.4688E−03 | 3.6488E−03 | 4.1064E−06 | 1.6271E−06 | 2.8557E−07 |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 3 and Table 4 as the following values and satisfy the following conditions:

Embodiment 2

| | | | |
|---|---|---|---|
| Fno | 2.09 | SD/TD | 0.92 |
| FOV | 76 | (R9 + R10)/(R9 − R10) | 0.37 |
| (R3 − R4)/(R3 + R4) | 0.72 | CT4/CT3 | 1.02 |
| f1/f | 0.75 | CT3/CT2 | 3.07 |
| f2/f | −1.16 | T23/T34 | 0.78 |
| f3/f | 5.50 | V2 − Vn, wherein n = 1, | −33.90 |
| | | 3, 4 and 5 | |
| f4/f | 0.49 | \|f5\| < \|fn\|, | Yes |
| | | wherein n = 1, 2, 3 and 4 | |
| f5/f | −0.42 | \|f5\| < \|f4\| < | Yes |
| | | \|fn\|, wherein n = 1, 2 | |
| | | and 3 | |

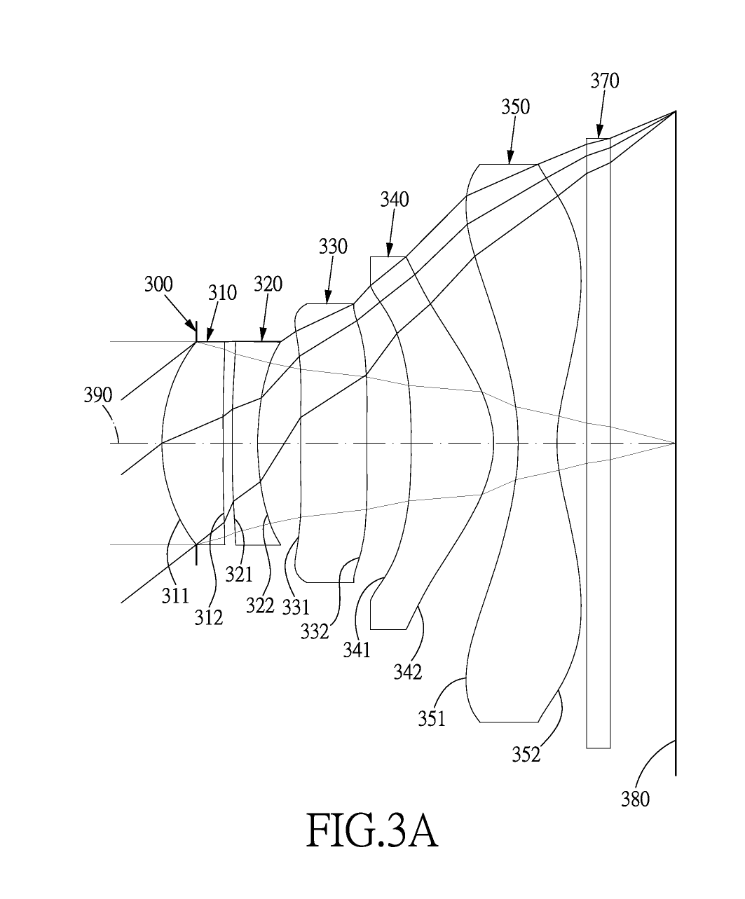

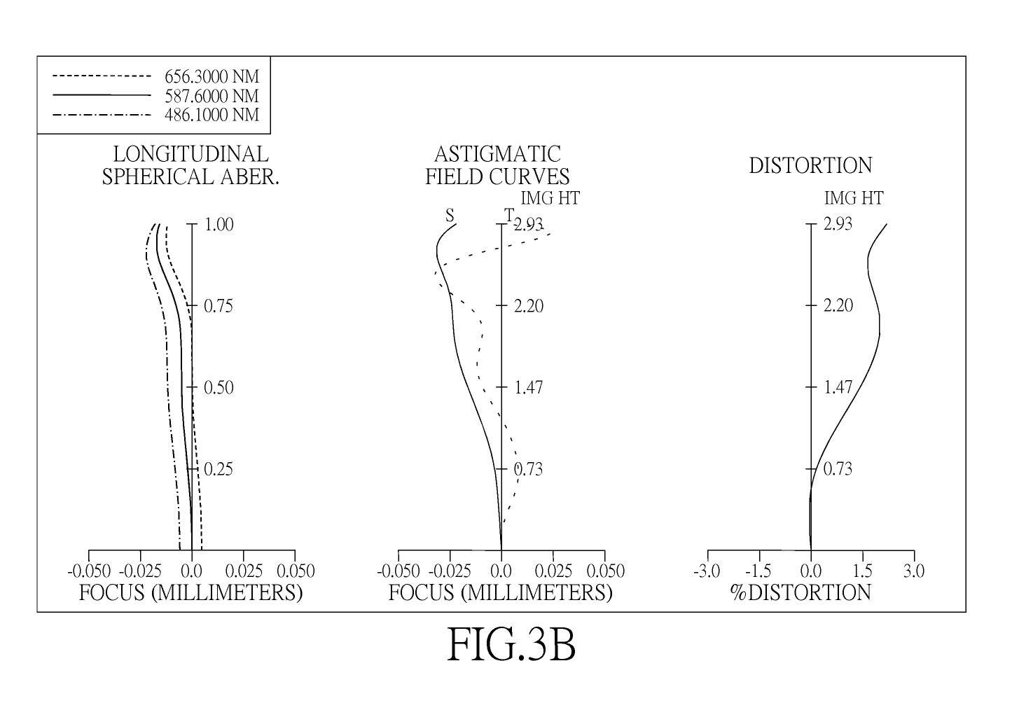

FIG. 3A shows an optical imaging lens in accordance with a third embodiment of the present invention, and FIG. 3B shows, in order from left to right, the longitudinal spherical aberration curves, the astigmatic field curves, and the distortion curve of the third embodiment of the present invention. An optical imaging lens in accordance with the third embodiment of the present invention comprises an aperture stop 300 and an optical assembly. The optical assembly comprises, in order from an object side to an image side: a first lens element 310, a second lens element 320, a third lens element 330, a fourth lens element 340, a fifth lens element 350, an IR cut filter 370 and an image plane 380, wherein the optical imaging lens has a total of five lens elements with refractive power. The aperture stop 300 is located between an image-side surface 312 of the first lens element 310 and an object to be photographed.

The first lens element 310 with a positive refractive power has an object-side surface 311 being convex near an optical axis 390 and the image-side surface 312 being concave near the optical axis 390, both the object-side and image-side surfaces 311, 312 are aspheric, and the first lens element 310 is made of plastic material.

The second lens element 320 with a negative refractive power has an object-side surface 321 being convex near the optical axis 390 and an image-side surface 322 being concave near the optical axis 390, both the object-side and image-side surfaces 321, 322 are aspheric, and the second lens element 320 is made of plastic material.

The third lens element 330 with a positive refractive power has an object-side surface 331 being convex near the optical axis 390 and an image-side surface 332 being concave near the optical axis 390, both the object-side and image-side surfaces 331, 332 are aspheric, the third lens element 330 is made of plastic material.

The fourth lens element 340 with a positive refractive power has an object-side surface 341 being concave near the optical axis 390 and an image-side surface 342 being convex near the optical axis 390, both the object-side and image-side surfaces 341, 342 are aspheric, the fourth lens element 340 is made of plastic material.

The fifth lens element 350 with a negative refractive power has an object-side surface 351 being concave near the optical axis 390 and an image-side surface 352 being concave near the optical axis 390, both the object-side and image-side surfaces 351, 352 are aspheric, the fifth lens element 350 is made of plastic material, and at least one inflection point is formed on the object-side surface 351 and the image-side surface 352 of the fifth lens element 350.

The IR cut filter 370 made of glass is located between the fifth lens element 350 and the image plane 380 and has no influence on the focal length of the optical imaging lens.

The detailed optical data of the third embodiment is shown in Table 5 and the aspheric surface data is shown in Table 6 below.

TABLE 5
(Embodiment 3)
f(focal length) = 3.74 mm, Fno = 2.09, HFOV = 37.5 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | | Plane | 0.00 | | | | |
| 2(Aperture | Lens 1 | 1.50(ASP) | 0.55 | Plastic | 1.544 | 55.9 | 2.81 |
| stop) | | | | | | | |
| 3 | | 70.00(ASP) | 0.08 | | | | |
| 4 | Lens 2 | 11.91(ASP) | 0.23 | Plastic | 1.642 | 22.0 | −4.86 |
| 5 | | 2.46(ASP) | 0.38 | | | | |
| 6 | Lens 3 | 12.83(ASP) | 0.59 | Plastic | 1.544 | 55.9 | 37.01 |
| 7 | | 34.75(ASP) | 0.40 | | | | |
| 8 | Lens 4 | −7.78(ASP) | 0.74 | Plastic | 1.544 | 55.9 | 1.73 |
| 9 | | −0.87(ASP) | 0.22 | | | | |
| 10 | Lens 5 | −2.13(ASP) | 0.35 | Plastic | 1.544 | 55.9 | −1.49 |
| 11 | | 1.38(ASP) | 0.27 | | | | |
| 12 | IR-filter | Plane | 0.21 | Glass | 1.517 | 64.2 | — |
| 13 | | Plane | 0.59 | | | | |
| 14 | Image | Plane | 0.00 | | | | |

Note:
Reference wavelength is 587.6 nm

TABLE 6
Aspheric Coefficients

| | Surface # | | | | |
|---|---|---|---|---|---|
| | 2 | 3 | 4 | 5 | 6 |
| k = | 1.0575E−01 | 9.0000E+01 | 4.1866E+00 | −9.8668E+00 | −8.9804E+01 |
| A4 = | 4.6413E−03 | 2.5249E−02 | −9.8424E−03 | 6.7488E−02 | −8.4859E−02 |
| A6 = | 4.8045E−03 | 1.2384E−02 | 6.2118E−02 | 4.4636E−02 | 8.0101E−03 |
| A8 = | −7.7547E−03 | −1.3217E−02 | −4.8487E−02 | 1.7293E−03 | −1.8606E−02 |
| A10 = | 1.4562E−02 | −1.6220E−02 | −3.0809E−02 | −1.6867E−02 | −1.0674E−03 |
| A12 = | 1.2242E−02 | −1.0413E−02 | 8.1297E−03 | −9.9207E−03 | 1.0009E−02 |
| A14 = | −2.2856E−02 | 2.3346E−04 | 1.1872E−02 | 6.4741E−02 | 8.6067E−03 |
| | Surface # | | | | |
| | 7 | 8 | 9 | 10 | 11 |
| k = | 8.9579E+01 | 2.8797E+01 | −3.5236E+00 | −1.4618E+01 | −1.1398E+01 |
| A4 = | −8.2333E−02 | −1.1206E−01 | −9.7371E−02 | −2.5087E−02 | −3.7060E−02 |
| A6 = | 2.4620E−02 | 7.6705E−02 | 5.9227E−02 | 5.4226E−03 | 7.0433E−03 |
| A8 = | −2.6939E−02 | −2.0404E−02 | −4.8279E−03 | 3.0661E−04 | −1.2750E−03 |
| A10 = | −1.1531E−03 | −1.1257E−02 | −2.1539E−03 | −6.2943E−05 | 5.1168E−05 |
| A12 = | 1.7614E−03 | −1.0908E−03 | −1.4156E−04 | −1.0907E−05 | 4.0997E−06 |
| A14 = | 5.0902E−03 | 3.4805E−03 | 1.2262E−04 | 1.7941E−06 | 2.7953E−07 |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 5 and Table 6 as the following values and satisfy the following conditions:

Embodiment 3

| | | | |
|---|---|---|---|
| Fno | 2.09 | SD/TD | 1.00 |
| FOV | 75.00 | (R9 + R10)/(R9 − R10) | 0.22 |
| (R3 − R4)/(R3 + R4) | 0.66 | CT4/CT3 | 1.24 |
| f1/f | 0.75 | CT3/CT2 | 2.58 |
| f2/f | −1.30 | T23/T34 | 0.96 |
| f3/f | 9.89 | V2 − Vn, wherein n = 1, | −33.90 |
| | | 3, 4 and 5 | |
| f4/f | 0.46 | \|f5\| < \|fn\|, | Yes |
| | | wherein n = 1, 2, 3 and 4 | |
| f5/f | −0.40 | \|f5\| < \|f4\| < | Yes |
| | | \|fn\|, wherein n = 1, 2 | |
| | | and 3 | |

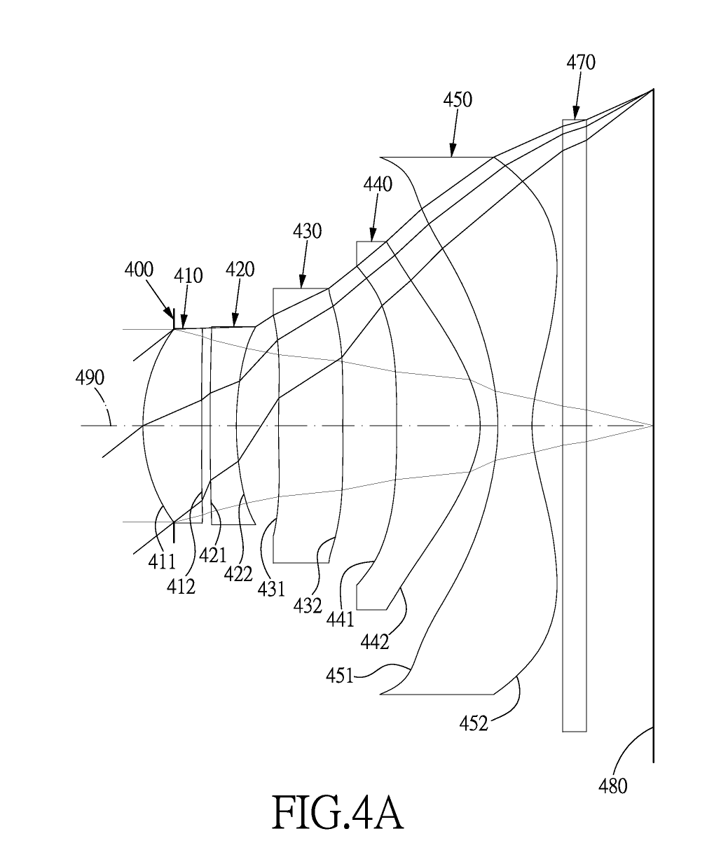

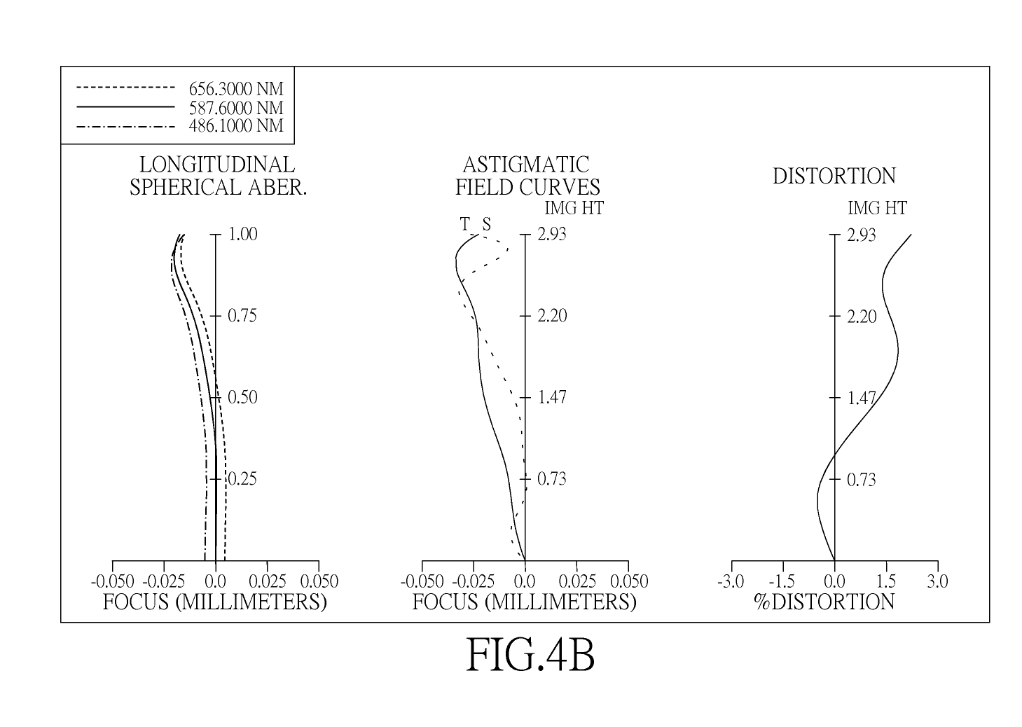

FIG. 4A shows an optical imaging lens in accordance with a fourth embodiment of the present invention, and FIG. 4B shows, in order from left to right, the longitudinal spherical aberration curves, the astigmatic field curves, and the distortion curve of the fourth embodiment of the present invention. An optical imaging lens in accordance with the fourth embodiment of the present invention comprises an aperture stop 400 and an optical assembly. The optical assembly comprises, in order from an object side to an image side: a first lens element 410, a second lens element 420, a third lens element 430, a fourth lens element 440, a fifth lens element 450, an IR cut filter 470 and an image plane 480, wherein the optical imaging lens has a total of five lens elements with refractive power. The aperture stop 400 is located between an image-side surface 412 of the first lens element 410 and an object to be photographed.

The first lens element 410 with a positive refractive power has an object-side surface 411 being convex near an optical axis 490 and the image-side surface 412 being concave near the optical axis 490, both the object-side and image-side surfaces 411, 412 are aspheric, and the first lens element 410 is made of plastic material.

The second lens element 420 with a negative refractive power has an object-side surface 421 being convex near the optical axis 490 and an image-side surface 422 being concave near the optical axis 490, both the object-side and image-side surfaces 421, 422 are aspheric, and the second lens element 420 is made of plastic material.

The third lens element 430 with a positive refractive power has an object-side surface 431 being convex near the optical axis 490 and an image-side surface 432 being concave near the optical axis 490, both the object-side and image-side surfaces 431, 432 are aspheric, the third lens element 430 is made of plastic material.

The fourth lens element 440 with a positive refractive power has an object-side surface 441 being concave near the optical axis 490 and an image-side surface 442 being convex near the optical axis 490, both the object-side and image-side surfaces 441, 442 are aspheric, the fourth lens element 440 is made of plastic material.

The fifth lens element 450 with a negative refractive power has an object-side surface 451 being concave near the optical axis 490 and an image-side surface 452 being concave near the optical axis 490, both the object-side and image-side surfaces 451, 452 are aspheric, the fifth lens element 450 is made of plastic material, and at least one inflection point is formed on the object-side surface 451 and the image-side surface 452 of the fifth lens element 450.

The IR cut filter 470 made of glass is located between the fifth lens element 450 and the image plane 480 and has no influence on the focal length of the optical imaging lens.

The detailed optical data of the fourth embodiment is shown in Table 7 and the aspheric surface data is shown in Table 8 below.

TABLE 7
(Embodiment 4)
f(focal length) = 3.7 mm, Fno = 2.2, HFOV = 37.84 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | | Plane | 0.00 | | | | |
| 2(Aperture | Lens 1 | 1.47(ASP) | 0.52 | Plastic | 1.544 | 55.9 | 2.78 |
| stop) | | | | | | | |
| 3 | | 51.00(ASP) | 0.08 | | | | |
| 4 | Lens 2 | 22.00(ASP) | 0.23 | Plastic | 1.642 | 22.0 | −4.84 |
| 5 | | 2.71(ASP) | 0.37 | | | | |
| 6 | Lens 3 | 12.82(ASP) | 0.57 | Plastic | 1.544 | 55.9 | 27.99 |
| 7 | | 80.00(ASP) | 0.48 | | | | |
| 8 | Lens 4 | −15.60(ASP) | 0.74 | Plastic | 1.544 | 55.9 | 1.43 |
| 9 | | −0.75(ASP) | 0.16 | | | | |
| 10 | Lens 5 | −1.74(ASP) | 0.30 | Plastic | 1.544 | 55.9 | −1.18 |
| 11 | | 1.09(ASP) | 0.27 | | | | |
| 12 | IR-filter | Plane | 0.21 | Glass | 1.517 | 64.2 | — |
| 13 | | Plane | 0.59 | | | | |
| 14 | Image | Plane | 0.00 | | | | |

Note:
Reference wavelength is 587.6 nm

TABLE 8
Aspheric Coefficients

| | Surface # | | | | |
|---|---|---|---|---|---|
| | 2 | 3 | 4 | 5 | 6 |
| k = | 1.2892E−01 | −8.0000E+01 | −2.0000E+01 | −1.4554E+01 | −9.0000E+01 |
| A4 = | 4.0578E−03 | −4.0400E−03 | −4.6871E−02 | 6.3807E−02 | −1.0663E−01 |
| A6 = | 1.2565E−02 | 5.0647E−02 | 1.3337E−01 | 5.7376E−02 | 4.3958E−02 |
| A8 = | −2.3995E−02 | −1.2388E−02 | −7.2167E−02 | 2.3359E−02 | −5.4300E−02 |
| A10 = | 2.5649E−02 | −5.7336E−02 | −7.9538E−02 | −3.1275E−02 | −2.9447E−03 |
| A12 = | 3.6933E−02 | −8.1703E−03 | 2.8815E−03 | −8.3270E−02 | 4.6171E−02 |
| A14 = | −5.5924E−02 | 8.4732E−05 | 4.5522E−02 | 1.4954E−01 | −1.5558E−02 |
| | Surface # | | | | |
| | 7 | 8 | 9 | 10 | 11 |
| k = | −9.0000E+01 | 9.0000E+01 | −4.0423E+00 | −1.4552E+01 | −1.1726E+01 |
| A4 = | −9.8167E−02 | −1.0564E−01 | −9.0206E−02 | −4.1001E−02 | −3.5836E−02 |
| A6 = | 3.6950E−02 | 3.9504E−02 | 4.2133E−02 | 7.8597E−04 | 4.3907E−03 |
| A8 = | −2.6990E−02 | −5.6487E−03 | −3.8257E−03 | 9.1252E−04 | −9.4731E−04 |
| A10 = | 1.3832E−03 | −4.8805E−03 | −6.7411E−04 | 2.4857E−04 | 2.8701E−05 |
| A12 = | 3.2831E−03 | −1.4849E−03 | 0.0000E+00 | −4.6267E−06 | 3.4130E−06 |
| A14 = | 3.0621E−03 | 1.2365E−03 | 0.0000E+00 | −9.0741E−06 | 1.0146E−07 |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 7 and Table 8 as the following values and satisfy the following conditions:

Embodiment 4

| | | | |
|---|---|---|---|
| Fno | 2.20 | SD/TD | 1.00 |
| FOV | 75.68 | (R9 + R10)/(R9 − R10) | 0.23 |
| (R3 − R4)/(R3 + R4) | 0.78 | CT4/CT3 | 1.30 |
| f1/f | 0.75 | CT3/CT2 | 2.46 |
| f2/f | −1.31 | T23/T34 | 0.78 |
| f3/f | 7.56 | V2 − Vn, wherein n = 1, | −33.90 |
| | | 3, 4 and 5 | |
| f4/f | 0.39 | \|f5\| < \|fn\|, | Yes |
| | | wherein n = 1, 2, 3 and 4 | |
| f5/f | −0.32 | \|f5\| < \|f4\| < | Yes |
| | | \|fn\|, wherein n = 1, 2 | |
| | | and 3 | |

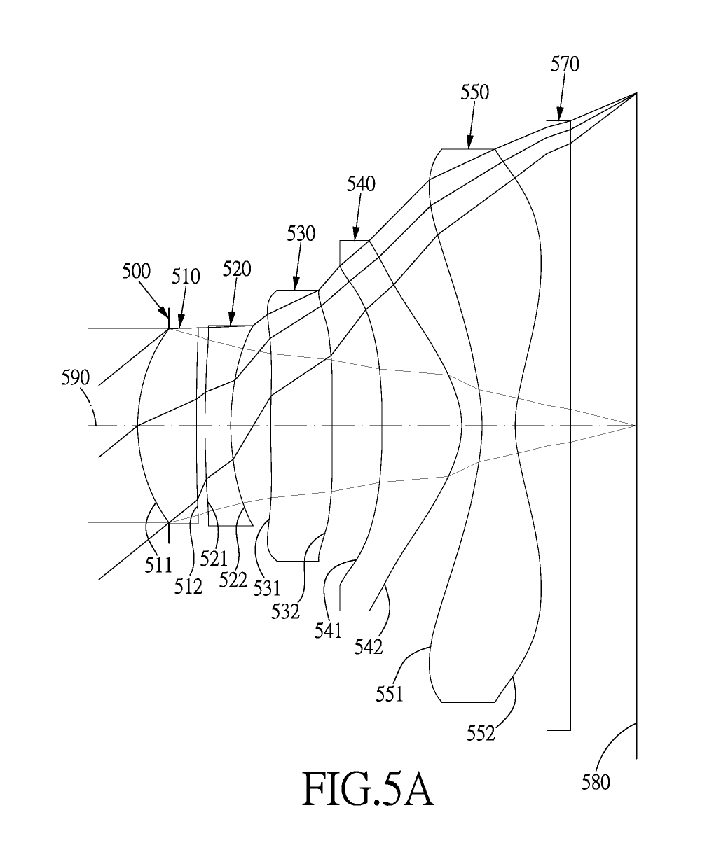

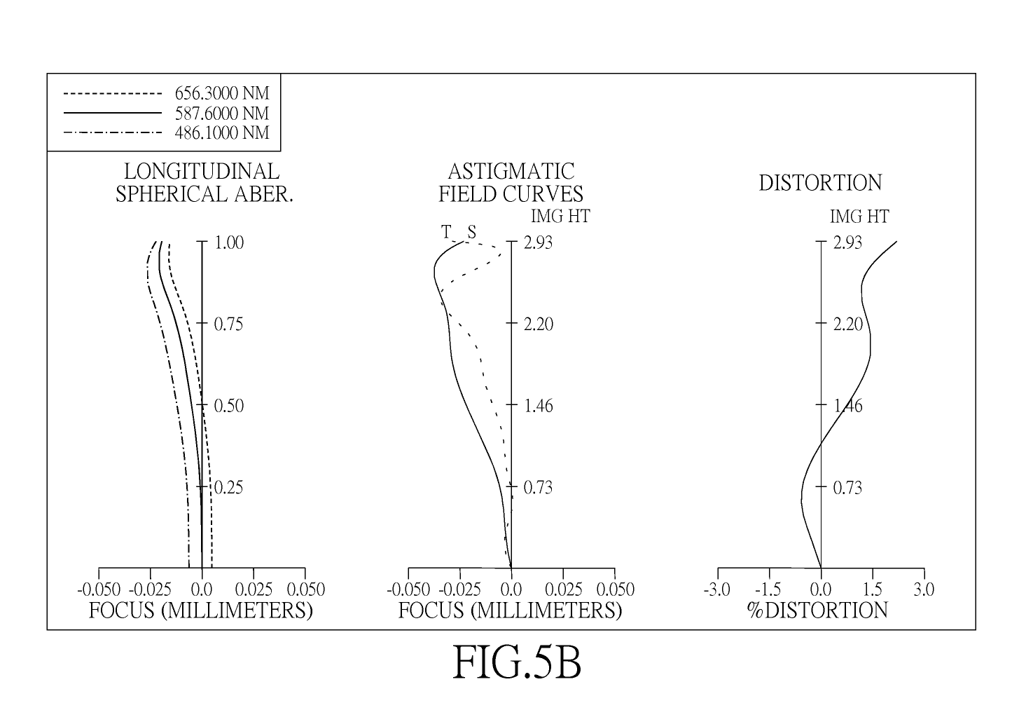

FIG. 5A shows an optical imaging lens in accordance with a fifth embodiment of the present invention, and FIG. 5B shows, in order from left to right, the longitudinal spherical aberration curves, the astigmatic field curves, and the distortion curve of the fifth embodiment of the present invention. An optical imaging lens in accordance with the fifth embodiment of the present invention comprises an aperture stop 500 and an optical assembly. The optical assembly comprises, in order from an object side to an image side: a first lens element 510, a second lens element 520, a third lens element 530, a fourth lens element 540, a fifth lens element 550, an IR cut filter 570 and an image plane 580, wherein the optical imaging lens has a total of five lens elements with refractive power. The aperture stop 500 is located between an image-side surface 512 of the first lens element 510 and an object to be photographed.

The first lens element 510 with a positive refractive power has an object-side surface 511 being convex near an optical axis 590 and the image-side surface 512 being concave near the optical axis 590, both the object-side and image-side surfaces 511, 512 are aspheric, and the first lens element 510 is made of plastic material.

The second lens element 520 with a negative refractive power has an object-side surface 521 being convex near the optical axis 590 and an image-side surface 522 being concave near the optical axis 590, both the object-side and image-side surfaces 521, 522 are aspheric, and the second lens element 520 is made of plastic material.

The third lens element 530 with a positive refractive power has an object-side surface 531 being convex near the optical axis 590 and an image-side surface 532 being concave near the optical axis 590, both the object-side and image-side surfaces 531, 532 are aspheric, the third lens element 530 is made of plastic material.

The fourth lens element 540 with a positive refractive power has an object-side surface 541 being concave near the optical axis 590 and an image-side surface 542 being convex near the optical axis 590, both the object-side and image-side surfaces 541, 542 are aspheric, the fourth lens element 540 is made of plastic material.

The fifth lens element 550 with a negative refractive power has an object-side surface 551 being concave near the optical axis 590 and an image-side surface 552 being concave near the optical axis 590, both the object-side and image-side surfaces 551, 552 are aspheric, the fifth lens element 550 is made of plastic material, and at least one inflection point is formed on the object-side surface 551 and the image-side surface 552 of the fifth lens element 550.

The IR cut filter 570 made of glass is located between the fifth lens element 550 and the image plane 580 and has no influence on the focal length of the optical imaging lens.

The detailed optical data of the fifth embodiment is shown in Table 9 and the aspheric surface data is shown in Table 10 below.

TABLE 9
(Embodiment 5)
f(focal length) = 3.59 mm, Fno = 2.1, HFOV = 38.67 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | | Plane | 0.00 | | | | |
| 2(Aperture | Lens 1 | 1.51(ASP) | 0.52 | Plastic | 1.544 | 55.9 | 2.81 |
| stop) | | | | | | | |
| 3 | | 80.00(ASP) | 0.08 | | | | |
| 4 | Lens 2 | 8.93(ASP) | 0.23 | Plastic | 1.642 | 22.0 | −4.70 |
| 5 | | 2.23(ASP) | 0.36 | | | | |
| 6 | Lens 3 | 11.86(ASP) | 0.55 | Plastic | 1.544 | 55.9 | 22.79 |
| 7 | | 270.83(ASP) | 0.44 | | | | |
| 8 | Lens 4 | −7.76(ASP) | 0.71 | Plastic | 1.544 | 55.9 | 1.36 |
| 9 | | −0.70(ASP) | 0.18 | | | | |
| 10 | Lens 5 | −1.53(ASP) | 0.30 | Plastic | 1.544 | 55.9 | −1.15 |
| 11 | | 1.13(ASP) | 0.28 | | | | |
| 12 | IR-filter | Plane | 0.21 | Glass | 1.517 | 64.2 | — |
| 13 | | Plane | 0.59 | | | | |
| 14 | Image | Plane | 0.00 | | | | |

Note:
Reference wavelength is 587.6 nm

TABLE 10
Aspheric Coefficients

| | Surface # | | | | |
|---|---|---|---|---|---|
| | 2 | 3 | 4 | 5 | 6 |
| k = | 1.1007E−01 | 5.0000E+01 | −2.0000E+01 | −8.7517E+00 | −5.0000E+01 |
| A4 = | 5.4747E−03 | 2.9779E−02 | −2.5172E−02 | 5.8930E−02 | −9.0466E−02 |
| A6 = | 1.0927E−02 | 1.9252E−02 | 8.4325E−02 | 4.8864E−02 | 1.3034E−02 |
| A8 = | −8.9372E−03 | −9.3119E−03 | −6.3105E−02 | 1.0366E−02 | −2.7776E−02 |
| A10 = | 1.5991E−02 | −2.6235E−02 | −5.6292E−02 | −2.9955E−02 | 9.6168E−03 |
| A12 = | 1.9356E−02 | −1.9961E−02 | 2.8332E−04 | −4.4626E−02 | 3.1124E−02 |
| A14 = | −2.7013E−02 | 2.3346E−04 | 1.7548E−02 | 9.3671E−02 | −4.5120E−03 |
| | Surface # | | | | |
| | 7 | 8 | 9 | 10 | 11 |
| k = | 5.0000E+01 | 2.8000E+01 | −3.7564E+00 | −2.0000E+01 | −1.1071E+01 |
| A4 = | −7.8625E−02 | −1.0425E−01 | −1.1589E−01 | −2.6691E−02 | −3.8942E−02 |
| A6 = | 1.3202E−02 | 6.8938E−02 | 7.3705E−02 | 5.4924E−03 | 7.7262E−03 |
| A8 = | −2.6030E−02 | −1.7157E−02 | −6.4595E−03 | 3.2491E−04 | −1.4678E−03 |
| A10 = | 9.9246E−04 | −1.0546E−02 | −3.2036E−03 | −7.6669E−05 | 4.8696E−05 |
| A12 = | 2.4677E−03 | −1.4112E−03 | −1.4156E−04 | −1.0907E−05 | 6.9560E−06 |
| A14 = | 6.6611E−03 | 3.1617E−03 | 1.8022E−04 | 2.1299E−06 | 2.7953E−07 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 9 and Table 10 as the following values and satisfy the following conditions:

Embodiment 5

| | | | |
|---|---|---|---|
| Fno | 2.10 | SD/TD | 1.00 |
| FOV | 77.34 | (R9 + R10)/(R9 − R10) | 0.15 |
| (R3 − R4)/(R3 + R4) | 0.60 | CT4/CT3 | 1.30 |
| f1/f | 0.78 | CT3/CT2 | 2.38 |
| f2/f | −1.31 | T23/T34 | 0.80 |
| f3/f | 6.35 | V2 − Vn, wherein n = 1, | −33.90 |
| | | 3, 4 and 5 | |
| f4/f | 0.38 | \|f5\| < \|fn\|, | Yes |
| | | wherein n = 1, 2, 3 and 4 | |
| f5/f | −0.32 | \|f5\| < \|f4\| < | Yes |
| | | \|fn\|, wherein n = 1, 2 | |
| | | and 3 | |

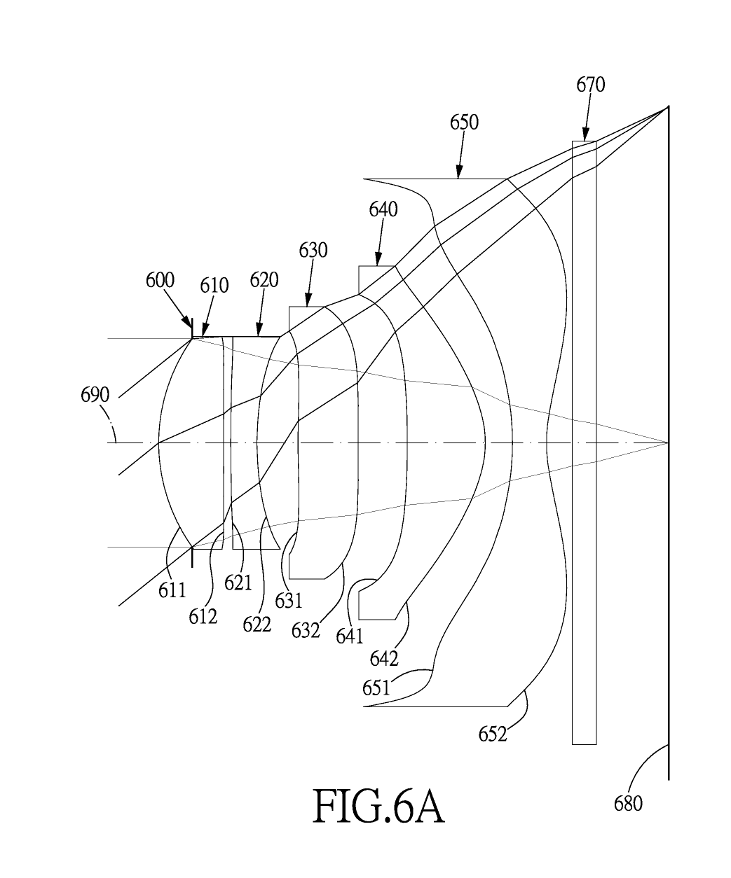

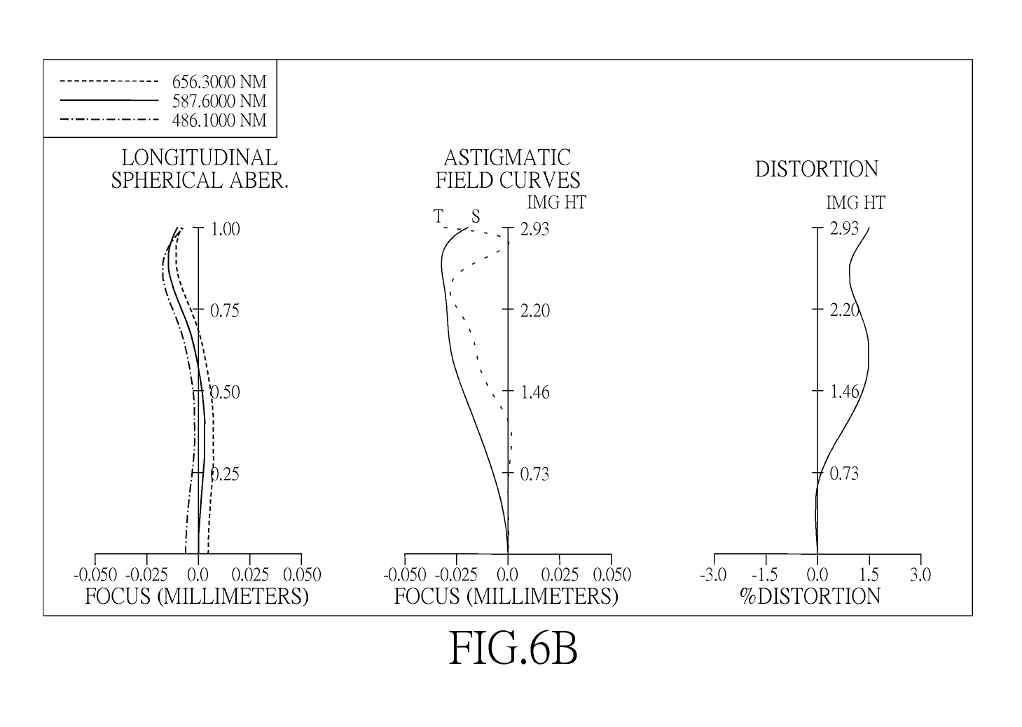

FIG. 6A shows an optical imaging lens in accordance with a sixth embodiment of the present invention, and FIG. 6B shows, in order from left to right, the longitudinal spherical aberration curves, the astigmatic field curves, and the distortion curve of the sixth embodiment of the present invention. An optical imaging lens in accordance with the sixth embodiment of the present invention comprises an aperture stop 600 and an optical assembly. The optical assembly comprises, in order from an object side to an image side: a first lens element 610, a second lens element 620, a third lens element 630, a fourth lens element 640, a fifth lens element 650, an IR cut filter 670 and an image plane 680, wherein the optical imaging lens has a total of five lens elements with refractive power. The aperture stop 600 is located between an image-side surface 612 of the first lens element 610 and an object to be photographed.

The first lens element 610 with a positive refractive power has an object-side surface 611 being convex near an optical axis 690 and the image-side surface 612 being concave near the optical axis 690, both the object-side and image-side surfaces 611, 612 are aspheric, and the first lens element 610 is made of plastic material.

The second lens element 620 with a negative refractive power has an object-side surface 621 being convex near the optical axis 690 and an image-side surface 622 being concave near the optical axis 690, both the object-side and image-side surfaces 621, 622 are aspheric, and the second lens element 620 is made of plastic material.

The third lens element 630 with a positive refractive power has an object-side surface 631 being convex near the optical axis 690 and an image-side surface 632 being concave near the optical axis 690, both the object-side and image-side surfaces 631, 632 are aspheric, the third lens element 630 is made of plastic material.

The fourth lens element 640 with a positive refractive power has an object-side surface 641 being concave near the optical axis 690 and an image-side surface 642 being convex near the optical axis 690, both the object-side and image-side surfaces 641, 642 are aspheric, the fourth lens element 640 is made of plastic material.

The fifth lens element 650 with a negative refractive power has an object-side surface 651 being concave near the optical axis 690 and an image-side surface 652 being concave near the optical axis 690, both the object-side and image-side surfaces 651, 652 are aspheric, the fifth lens element 650 is made of plastic material, and at least one inflection point is formed on the object-side surface 651 and the image-side surface 652 of the fifth lens element 650.

The IR cut filter 670 made of glass is located between the fifth lens element 650 and the image plane 680 and has no influence on the focal length of the optical imaging lens.

The detailed optical data of the sixth embodiment is shown in Table 11 and the aspheric surface data is shown in Table 12 below.

TABLE 11
(Embodiment 6)
f(focal length) = 3.63 mm, Fno = 2.0, HFOV = 38.5 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | | Plane | 0.00 | | | | |
| 2(Aperture | Lens 1 | 1.55(ASP) | 0.57 | Plastic | 1.544 | 55.9 | 2.91 |
| stop) | | | | | | | |
| 3 | | 60.00(ASP) | 0.06 | | | | |
| 4 | Lens 2 | 14.50(ASP) | 0.23 | Plastic | 1.642 | 22.0 | −4.88 |
| 5 | | 2.56(ASP) | 0.36 | | | | |
| 6 | Lens 3 | 8.80(ASP) | 0.53 | Plastic | 1.544 | 55.9 | 19.99 |
| 7 | | 45.00(ASP) | 0.43 | | | | |
| 8 | Lens 4 | −9.62(ASP) | 0.69 | Plastic | 1.544 | 55.9 | 1.72 |
| 9 | | −0.88(ASP) | 0.24 | | | | |
| 10 | Lens 5 | −2.17(ASP) | 0.30 | Plastic | 1.544 | 55.9 | −1.45 |
| 11 | | 1.30(ASP) | 0.23 | | | | |
| 12 | IR-filter | Plane | 0.21 | Glass | 1.517 | 64.2 | — |
| 13 | | Plane | 0.64 | | | | |
| 14 | Image | Plane | 0.00 | | | | |

Note:
Reference wavelength is 587.6 nm

TABLE 12
Aspheric Coefficients

| | Surface # | | | | |
|---|---|---|---|---|---|
| | 2 | 3 | 4 | 5 | 6 |
| k = | 1.0598E−01 | −7.0000E+01 | −1.9221E+01 | −2.0000E+01 | 3.3910E+01 |
| A4 = | −2.9184E−03 | −4.7691E−02 | −1.0171E−01 | 8.4976E−02 | −1.2538E−01 |
| A6 = | 1.5737E−02 | 1.2384E−01 | 2.6650E−01 | 4.7447E−02 | 3.0272E−02 |
| A8 = | −3.6445E−02 | −5.3330E−02 | −1.6286E−01 | −3.0346E−03 | −5.4907E−02 |
| A10 = | 1.4850E−02 | −1.0269E−01 | −1.2265E−01 | 2.6503E−02 | −2.1676E−02 |
| A12 = | 5.0903E−02 | −1.7257E−02 | 2.2398E−02 | −1.6490E−01 | 8.2546E−02 |
| A14 = | −6.1256E−02 | 5.4282E−02 | 8.9143E−02 | 1.5499E−01 | −7.4553E−02 |
| | Surface # | | | | |
| | 7 | 8 | 9 | 10 | 11 |
| k = | 5.3356E+01 | −4.9140E+01 | −3.9070E+00 | −1.7997E+01 | −1.1141E+01 |
| A4 = | −9.7663E−02 | −7.1479E−02 | −9.1524E−02 | −7.4349E−02 | −5.9557E−02 |
| A6 = | 2.4375E−02 | 1.9235E−02 | 5.6272E−02 | −8.0804E−03 | 1.5398E−02 |
| A8 = | −6.9326E−02 | 7.6385E−03 | −2.1018E−02 | 1.8250E−02 | −4.0913E−03 |
| A10 = | 3.1458E−02 | −5.2543E−02 | 1.3827E−03 | −6.7646E−03 | 6.7536E−04 |
| A12 = | −5.3607E−03 | 3.5323E−02 | 1.7678E−03 | 1.3477E−03 | −8.5081E−05 |
| A14 = | −4.1402E−03 | −1.0509E−02 | −3.1126E−04 | −1.1549E−04 | 6.0916E−06 |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 11 and Table 12 as the following values and satisfy the following conditions:

Embodiment 6

| | | | |
|---|---|---|---|
| Fno | 2.00 | SD/TD | 1.00 |
| FOV | 77.00 | (R9 + R10)/(R9 − R10) | 0.25 |
| (R3 − R4)/(R3 + R4) | 0.70 | CT4/CT3 | 1.30 |
| f1/f | 0.80 | CT3/CT2 | 2.30 |
| f2/f | −1.34 | T23/T34 | 0.83 |
| f3/f | 5.51 | V2 − Vn, wherein n = 1, | −33.90 |
| | | 3, 4 and 5 | |
| f4/f | 0.47 | \|f5\| < \|fn\|, | Yes |
| | | wherein n = 1, 2, 3 and 4 | |
| f5/f | −0.40 | \|f5\| < \|f4\| < | Yes |
| | | \|fn\|, wherein n = 1, 2 | |
| | | and 3 | |

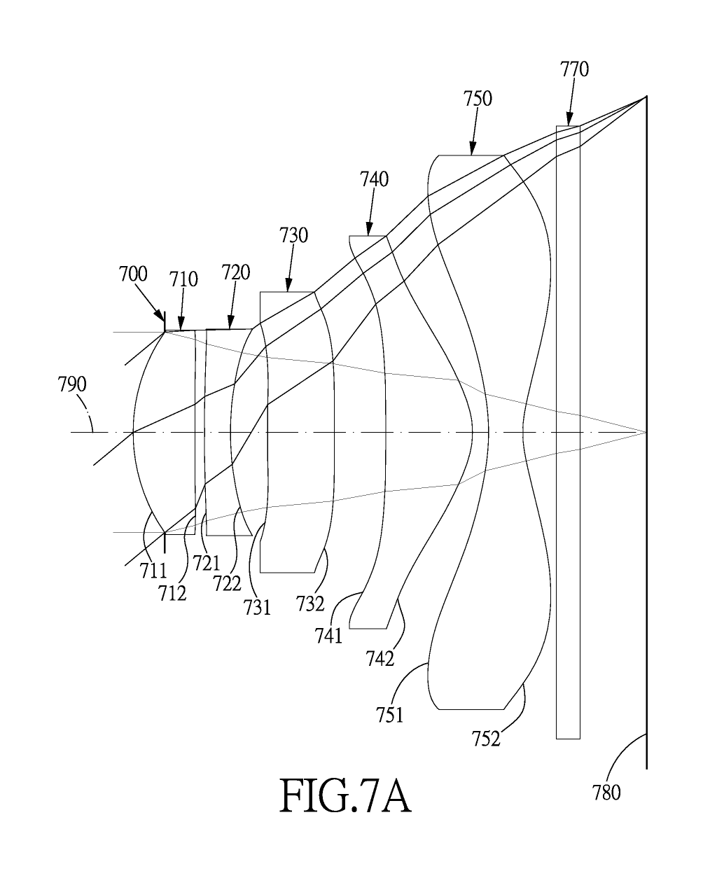

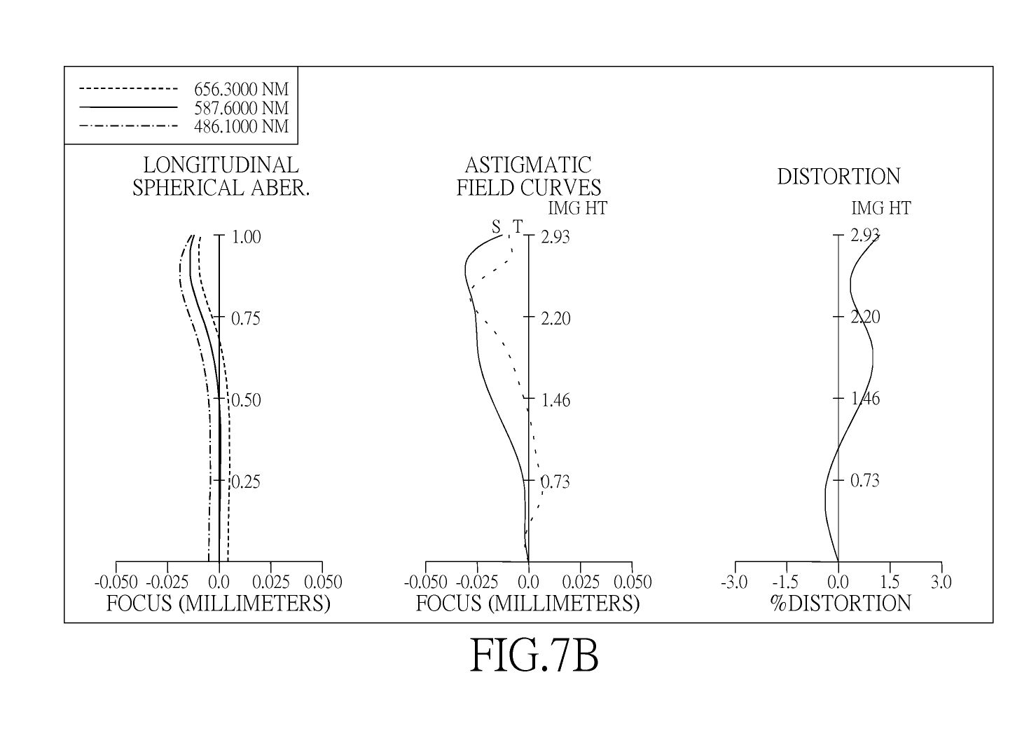

FIG. 7A shows an optical imaging lens in accordance with a seventh embodiment of the present invention, and FIG. 7B shows, in order from left to right, the longitudinal spherical aberration curves, the astigmatic field curves, and the distortion curve of the seventh embodiment of the present invention. An optical imaging lens in accordance with the seventh embodiment of the present invention comprises an aperture stop 700 and an optical assembly. The optical assembly comprises, in order from an object side to an image side: a first lens element 710, a second lens element 720, a third lens element 730, a fourth lens element 740, a fifth lens element 750, an IR cut filter 770 and an image plane 780, wherein the optical imaging lens has a total of five lens elements with refractive power. The aperture stop 700 is located between an image-side surface 712 of the first lens element 710 and an object to be photographed.

The first lens element 710 with a positive refractive power has an object-side surface 711 being convex near an optical axis 790 and the image-side surface 712 being concave near the optical axis 790, both the object-side and image-side surfaces 711, 712 are aspheric, and the first lens element 710 is made of plastic material.

The second lens element 720 with a negative refractive power has an object-side surface 721 being convex near the optical axis 790 and an image-side surface 722 being concave near the optical axis 790, both the object-side and image-side surfaces 721, 722 are aspheric, and the second lens element 720 is made of plastic material.

The third lens element 730 with a positive refractive power has an object-side surface 731 being convex near the optical axis 790 and an image-side surface 732 being concave near the optical axis 790, both the object-side and image-side surfaces 731, 732 are aspheric, the third lens element 730 is made of plastic material.

The fourth lens element 740 with a positive refractive power has an object-side surface 741 being concave near the optical axis 790 and an image-side surface 742 being convex near the optical axis 790, both the object-side and image-side surfaces 741, 742 are aspheric, the fourth lens element 740 is made of plastic material.

The fifth lens element 750 with a negative refractive power has an object-side surface 751 being concave near the optical axis 790 and an image-side surface 752 being concave near the optical axis 790, both the object-side and image-side surfaces 751, 752 are aspheric, the fifth lens element 750 is made of plastic material, and at least one inflection point is formed on the object-side surface 751 and the image-side surface 752 of the fifth lens element 750.

The IR cut filter 770 made of glass is located between the fifth lens element 750 and the image plane 780 and has no influence on the focal length of the optical imaging lens.

The detailed optical data of the seventh embodiment is shown in Table 13 and the aspheric surface data is shown in Table 14 below.

TABLE 13
(Embodiment 7)
f(focal length) = 3.58 mm, Fno = 2.05, HFOV = 39 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | | Plane | 0.00 | | | | |
| 2(Aperture | Lens 1 | 1.53(ASP) | 0.54 | Plastic | 1.544 | 55.9 | 2.86 |
| stop) | | | | | | | |
| 3 | | 80.00(ASP) | 0.08 | | | | |
| 4 | Lens 2 | 13.88(ASP) | 0.23 | Plastic | 1.642 | 22.0 | −4.67 |
| 5 | | 2.45(ASP) | 0.33 | | | | |
| 6 | Lens 3 | 12.12(ASP) | 0.59 | Plastic | 1.544 | 55.9 | 26.85 |
| 7 | | 70.00(ASP) | 0.46 | | | | |
| 8 | Lens 4 | −40.00(ASP) | 0.77 | Plastic | 1.544 | 55.9 | 1.25 |
| 9 | | −0.67(ASP) | 0.14 | | | | |
| 10 | Lens 5 | −1.61(ASP) | 0.30 | Plastic | 1.544 | 55.9 | −1.06 |
| 11 | | 0.96(ASP) | 0.29 | | | | |
| 12 | IR-filter | Plane | 0.21 | Glass | 1.517 | 64.2 | — |
| 13 | | Plane | 0.59 | | | | |
| 14 | Image | Plane | 0.00 | | | | |

Note:
Reference wavelength is 587.6 nm

TABLE 14
Aspheric Coefficients

| | Surface # | | | | |
|---|---|---|---|---|---|
| | 2 | 3 | 4 | 5 | 6 |
| k = | 1.2471E−01 | −7.0000E+01 | −1.1776E+01 | −1.5456E+01 | −2.2770E+01 |
| A4 = | 1.5914E−03 | −7.1406E−03 | −6.6193E−02 | 6.7370E−02 | −1.2034E−01 |
| A6 = | 9.2101E−03 | 6.2055E−02 | 1.8881E−01 | 6.0524E−02 | 1.3166E−02 |
| A8 = | −1.4989E−02 | −2.3241E−02 | −1.2722E−01 | −1.4772E−02 | −2.5734E−02 |
| A10 = | 9.2644E−03 | −8.6886E−02 | −1.0086E−01 | 1.7660E−02 | 3.9988E−03 |
| A12 = | 2.8298E−02 | −2.7618E−02 | 5.8914E−03 | −1.2937E−01 | 4.3498E−03 |
| A14 = | −4.5551E−02 | 5.0552E−02 | 8.8522E−02 | 1.4363E−01 | 2.8178E−03 |
| | Surface # | | | | |
| | 7 | 8 | 9 | 10 | 11 |
| k = | −7.0000E+01 | 4.0000E+01 | −4.0343E+00 | −2.0000E+01 | −1.0173E+01 |
| A4 = | −8.5545E−02 | −7.6506E−02 | −8.8352E−02 | −5.5714E−02 | −4.6779E−02 |
| A6 = | 4.4673E−03 | 4.8824E−02 | 6.1016E−02 | 1.3467E−02 | 1.1951E−02 |
| A8 = | −2.3412E−02 | −1.5146E−02 | −8.4404E−03 | 7.8127E−04 | −2.5999E−03 |
| A10 = | 1.3333E−02 | −1.1351E−02 | −9.9472E−04 | −3.1303E−04 | 1.6290E−04 |
| A12 = | −7.3613E−03 | 7.0774E−03 | −6.8198E−05 | −2.4007E−05 | 1.3478E−05 |
| A14 = | 5.4857E−03 | −9.5227E−04 | 6.9028E−05 | 6.1483E−06 | −1.1731E−06 |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 13 and Table 14 as the following values and satisfy the following conditions:

Embodiment 7

| | | | |
|---|---|---|---|
| Fno | 2.05 | SD/TD | 1.00 |
| FOV | 78 | (R9 + R10)/(R9 − R10) | 0.25 |
| (R3 − R4)/(R3 + R4) | 0.70 | CT4/CT3 | 1.30 |
| f1/f | 0.80 | CT3/CT2 | 2.56 |
| f2/f | −1.30 | T23/T34 | 0.72 |
| f3/f | 7.50 | V2 − Vn, wherein n = 1, | −33.90 |
| | | 3, 4 and 5 | |
| f4/f | 0.35 | \|f5\| < \|fn\|, | Yes |
| | | wherein n = 1, 2, 3 and 4 | |
| f5/f | −0.30 | \|f5\| < \|f4\| < | Yes |
| | | \|fn\|, wherein n = 1, 2 | |
| | | and 3 | |

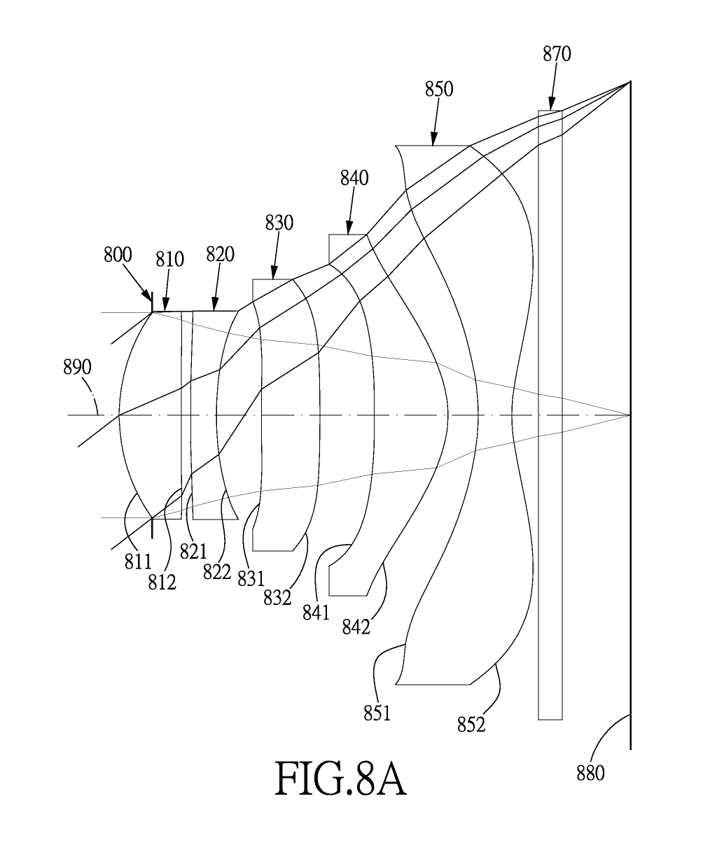

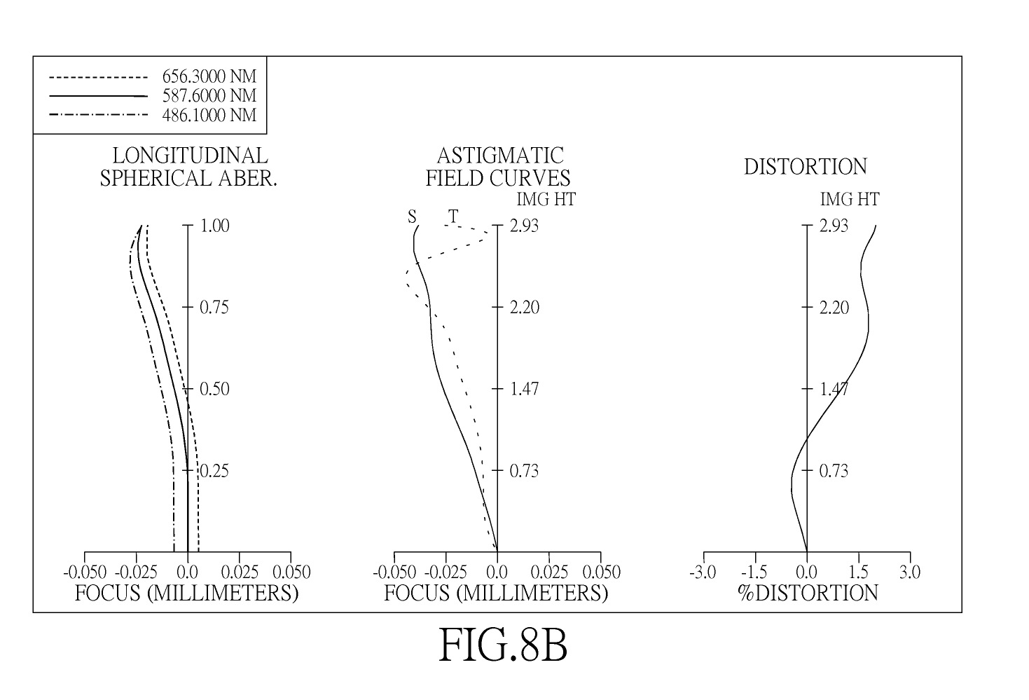

FIG. 8A shows an optical imaging lens in accordance with an eighth embodiment of the present invention, and FIG. 8B shows, in order from left to right, the longitudinal spherical aberration curves, the astigmatic field curves, and the distortion curve of the eighth embodiment of the present invention. An optical imaging lens in accordance with the eighth embodiment of the present invention comprises an aperture stop 800 and an optical assembly. The optical assembly comprises, in order from an object side to an image side: a first lens element 810, a second lens element 820, a third lens element 830, a fourth lens element 840, a fifth lens element 850, an IR cut filter 870 and an image plane 880, wherein the optical imaging lens has a total of five lens elements with refractive power. The aperture stop 800 is located between an image-side surface 812 of the first lens element 810 and an object to be photographed.

The first lens element 810 with a positive refractive power has an object-side surface 811 being convex near an optical axis 890 and the image-side surface 812 being concave near the optical axis 890, both the object-side and image-side surfaces 811, 812 are aspheric, and the first lens element 810 is made of plastic material.

The second lens element 820 with a negative refractive power has an object-side surface 821 being convex near the optical axis 890 and an image-side surface 822 being concave near the optical axis 890, both the object-side and image-side surfaces 821, 822 are aspheric, and the second lens element 820 is made of plastic material.

The third lens element 830 with a positive refractive power has an object-side surface 831 being convex near the optical axis 890 and an image-side surface 832 being convex near the optical axis 890, both the object-side and image-side surfaces 831, 832 are aspheric, the third lens element 830 is made of plastic material.

The fourth lens element 840 with a positive refractive power has an object-side surface 841 being concave near the optical axis 890 and an image-side surface 842 being convex near the optical axis 890, both the object-side and image-side surfaces 841, 842 are aspheric, the fourth lens element 840 is made of plastic material.

The fifth lens element 850 with a negative refractive power has an object-side surface 851 being concave near the optical axis 890 and an image-side surface 852 being concave near the optical axis 890, both the object-side and image-side surfaces 851, 852 are aspheric, the fifth lens element 850 is made of plastic material, and at least one inflection point is formed on the object-side surface 851 and the image-side surface 852 of the fifth lens element 850.

The IR cut filter 870 made of glass is located between the fifth lens element 850 and the image plane 880 and has no influence on the focal length of the optical imaging lens.

The detailed optical data of the eighth embodiment is shown in Table 15 and the aspheric surface data is shown in Table 16 below.

TABLE 15
(Embodiment 8)
f(focal length) = 3.79 mm, Fno = 2.1, HFOV = 37.26 deg.

| | | | | | | | Focal |
|---|---|---|---|---|---|---|---|
| Surface | | Curvature Radius | Thickness | Material | index | Abbe # | length |
| 0 | Object | Plane | Infinity | | | | |
| 1 | | Plane | 0.00 | | | | |
| 2(Aperture | Lens 1 | 1.56(ASP) | 0.55 | Plastic | 1.544 | 55.9 | 2.88 |
| stop) | | | | | | | |
| 3 | | 201.06(ASP) | 0.08 | | | | |
| 4 | Lens 2 | 14.01(ASP) | 0.23 | Plastic | 1.642 | 22.0 | −4.94 |
| 5 | | 2.57(ASP) | 0.40 | | | | |
| 6 | Lens 3 | 14.93(ASP) | 0.52 | Plastic | 1.544 | 55.9 | 20.89 |
| 7 | | −47.04(ASP) | 0.49 | | | | |
| 8 | Lens 4 | −7.91(ASP) | 0.65 | Plastic | 1.533 | 55.6 | 1.87 |
| 9 | | −0.91(ASP) | 0.27 | | | | |
| 10 | Lens 5 | −1.87(ASP) | 0.30 | Plastic | 1.515 | 57.0 | −1.52 |
| 11 | | 1.41(ASP) | 0.24 | | | | |
| 12 | IR-filter | Plane | 0.21 | Glass | 1.517 | 64.2 | — |
| 13 | | Plane | 0.61 | | | | |
| 14 | Image | Plane | 0.00 | | | | |

Note:
Reference wavelength is 587.6 nm

TABLE 16
Aspheric Coefficients

| | Surface # | | | | |
|---|---|---|---|---|---|
| | 2 | 3 | 4 | 5 | 6 |
| k = | 6.9757E−02 | −6.9752E+01 | −2.0000E+01 | −1.2466E+01 | −1.8059E+01 |
| A4 = | 1.5668E−03 | 8.6727E−04 | −4.1754E−02 | 5.8589E−02 | −9.8450E−02 |
| A6 = | 1.3147E−02 | 3.6338E−02 | 1.1101E−01 | 5.0121E−02 | 1.1373E−02 |
| A8 = | −2.2163E−02 | −1.1310E−02 | −5.5436E−02 | 5.7347E−03 | −2.9606E−02 |
| A10 = | 1.2857E−02 | −3.5888E−02 | −6.7105E−02 | −3.1799E−02 | 4.0107E−03 |
| A12 = | 2.9343E−02 | −4.4726E−02 | −2.0220E−02 | −3.2122E−02 | 8.4939E−03 |
| A14 = | −3.8414E−02 | 3.5618E−02 | 6.3767E−02 | 7.0575E−02 | −7.1266E−03 |
| | Surface # | | | | |
| | 7 | 8 | 9 | 10 | 11 |
| k = | 6.9981E+01 | 3.3532E+01 | −3.7448E+00 | −1.1758E+01 | −1.3236E+01 |
| A4 = | −8.7623E−02 | −6.1723E−02 | −7.5914E−02 | −4.6853E−02 | −3.7438E−02 |
| A6 = | 7.5277E−03 | 1.4671E−02 | 4.0770E−02 | 6.8233E−03 | 5.9978E−03 |
| A8 = | −2.7395E−02 | 5.9775E−03 | −4.7198E−03 | 9.9315E−04 | −1.1365E−03 |
| A10 = | 5.7589E−03 | −1.6792E−02 | −3.8650E−04 | −8.0299E−05 | 2.5079E−05 |
| A12 = | −1.2269E−03 | 4.6745E−03 | −7.8476E−05 | −6.3999E−07 | 4.7228E−06 |
| A14 = | 1.5780E−03 | −3.5536E−04 | 5.8894E−05 | −2.3814E−06 | 5.1745E−08 |

In the 8th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from Table 15 and Table 16 as the following values and satisfy the following conditions:

Embodiment 8

| | | | |
|---|---|---|---|
| Fno | 2.10 | SD/TD | 1.00 |
| FOV | 74.52 | (R9 + R10)/(R9 − 10) | 0.14 |
| (R3 − R4)/ | 0.69 | CT4/CT3 | 1.26 |
| (R3 + R4) | | | |
| f1/f | 0.76 | CT3/CT2 | 2.26 |
| f2/f | −1.30 | T23/T34 | 0.82 |
| f3/f | 5.51 | V2 − Vn, wherein n = 1, | −33.9 when n = 1 and 3; |
| | | 3, 4 and 5 | −33.6 when n = 4; |
| | | | −35 when n = 5 |
| f4/f | 0.49 | \|f5\| < \|fn\|, | Yes |
| | | wherein n = 1, 2, 3 and 4 | |
| f5/f | −0.40 | \|f5\| < \|f4\| < | Yes |
| | | \|fn\|, wherein n = 1, 2 | |
| | | and 3 | |

In the present optical imaging lens, the lens elements can be made of plastic or glass. If the lens elements are made of plastic, the cost will be effectively reduced. If the lens elements are made of glass, there is more freedom in distributing the refractive power of the optical imaging lens. Plastic lens elements can have aspheric surfaces, which allow more design parameter freedom (than spherical surfaces), so as to reduce the aberration and the number of the lens elements, as well as the total track length of the optical imaging lens.

In the present optical imaging lens, if the object-side or the image-side surface of the lens elements with refractive power is convex and the location of the convex surface is not defined, the object-side or the image-side surface of the lens elements near the optical axis is convex. If the object-side or the image-side surface of the lens elements is concave and the location of the concave surface is not defined, the object-side or the image-side surface of the lens elements near the optical axis is concave.

The optical imaging lens of the present invention can be used in focusing optical systems and can obtain better image quality. The optical imaging lens of the present invention can also be used in electronic imaging systems, such as, 3D image capturing, digital camera, mobile device, digital flat panel or vehicle camera.

The embodiments depicted above and the appended drawings are exemplary and are not intended to be exhaustive or to limit the scope of the present disclosure to the precise forms disclosed. Many modifications and variations are possible in view of the above teachings.

While we have shown and described various embodiments in accordance with the present invention, it should be clear to those skilled in the art that further embodiments may be made without departing from the scope of the present invention.

What is claimed is:

1. An optical imaging lens comprising an aperture stop and an optical assembly, the optical assembly comprising: in order from an object side to an image side:
a first lens element with a positive refractive power having an aspheric object-side surface being convex near an optical axis and an aspheric image-side surface, the first lens element being made of plastic material;
a second lens element with a negative refractive power having an aspheric object-side surface being convex near an optical axis and an aspheric image-side surface being concave near an optical axis, the second lens element being made of plastic material;
a third lens element with a positive refractive power having an aspheric object-side surface being convex near an optical axis and an aspheric image-side surface, the third lens element being made of plastic material;
a fourth lens element with a positive refractive power having an aspheric object-side surface being concave near an optical axis and an aspheric image-side surface being convex near an optical axis, the fourth lens element being made of plastic material;
a fifth lens element with a negative refractive power having an aspheric object-side surface being concave near an optical axis and an aspheric image-side surface being concave near an optical axis, the fifth lens element being made of plastic material, at least one inflection point being formed on the object-side and the image-side surfaces of the fifth lens element;
the aperture stop being located between the image-side surface of the first lens element and an object to be photographed;
wherein a focal length of the optical imaging lens is f, a focal length of the first lens element is f1, a focal length of the second lens element is f2, a focal length of the third lens element is f3, a focal length of the fourth lens element is f4, a focal length of the fifth lens element is f5, a radius of curvature of the object-side surface of the fifth lens element is R9, a radius of curvature of the image-side surface of the fifth lens element is R10, and the following conditions are satisfied:

|f5|<|fn|, wherein n=1,2,3 and 4;
−0.45<f5/f<−0.2;
0<(R9+R10)/(R9−R10)<0.5.

2. The optical imaging lens as claimed in claim 1, wherein the focal length of the optical imaging lens is f, the focal length of the first lens element is f1, and the following condition is satisfied:
0.7<f1/f<0.81.

3. The optical imaging lens as claimed in claim 1, wherein the focal length of the optical imaging lens is f, the focal length of the second lens element is f2, and the following condition is satisfied:
−1.5<f2/f<−1.

4. The optical imaging lens as claimed in claim 3, wherein a radius of curvature of the object-side surface of the second lens element is R3, a radius of curvature of the image-side surface of the second lens element is R4, and the following condition is satisfied:
0.5<(R3−R4)/(R3+R4)<0.85.

5. The optical imaging lens as claimed in claim 1, wherein a distance along the optical axis between the aperture stop and the image-side surface of the fifth lens element is SD, a distance along the optical axis between the object-side surface of the first lens element and the image-side surface of the fifth lens element is TD, and the following condition is satisfied:
0.89<SD/TD<1.05.

6. The optical imaging lens as claimed in claim 5, wherein a central thickness of the second lens element is CT2, a central thickness of the third lens element is CT3, and the following condition is satisfied:
2<CT3/CT2<3.5.

7. The optical imaging lens as claimed in claim 5, wherein the focal length of the optical imaging lens is f, the focal length of the third lens element is f3, and the following condition is satisfied:
4.5<f3/f<12.

8. The optical imaging lens as claimed in claim 1, wherein the focal length of the optical imaging lens is f, the focal length of the fourth lens element is f4, and the following condition is satisfied:
0.25<f4/f<0.6.

9. The optical imaging lens as claimed in claim 5, wherein a distance along the optical axis between the second lens element and the third lens element is T23, a distance along the optical axis between the third lens element and the fourth lens element is T34, and the following condition is satisfied:
0.6<T23/T34≦1.

10. The optical imaging lens as claimed in claim 5, wherein an Abbe number of the first lens element is V1, an Abbe number of the second lens element is V2, an Abbe number of the third lens element is V3, an Abbe number of the fourth lens element is V4, an Abbe number of the fifth lens element is V5, and the following condition is satisfied:
−40<V2−Vn<−25, wherein n=1,3,4 and 5.

11. An optical imaging lens comprising an aperture stop and an optical assembly, the optical assembly comprising: in order from an object side to an image side:
a first lens element with a positive refractive power having an aspheric object-side surface being convex near an optical axis and an aspheric image-side surface;
a second lens element with a negative refractive power having an aspheric object-side surface being convex near an optical axis and an aspheric image-side surface being concave near an optical axis, the second lens element being made of plastic material;
a third lens element with a positive refractive power having an aspheric object-side surface being convex near an optical axis and an aspheric image-side surface, the third lens element being made of plastic material;
a fourth lens element with a positive refractive power having an aspheric object-side surface and an aspheric image-side surface being convex near an optical axis, the fourth lens element being made of plastic material;
a fifth lens element with a negative refractive power having an aspheric object-side surface being concave near an optical axis and an aspheric image-side surface being concave near an optical axis, the fifth lens element being made of plastic material, at least one inflection point being formed on the object-side and the image-side surfaces of the fifth lens element;
the aperture stop being located between the image-side surface of the first lens element and an object to be photographed;
wherein a focal length of the optical imaging lens is f, a focal length of the first lens element is f1, a focal length of the second lens element is f2, a focal length of the third lens element is f3, a focal length of the fourth lens element is f4, a focal length of the fifth lens element is f5, a radius of curvature of the object-side surface of the second lens element is R3, a radius of curvature of the image-side surface of the second lens element is R4, and the following conditions are satisfied:

|f5|<|f4|<|fn|, wherein n=1,2 and 3;
0.5<(R3−R4)/(R3+R4)<0.85.

12. The optical imaging lens as claimed in claim 11, wherein the focal length of the optical imaging lens is f, the focal length of the first lens element is f1, and the following condition is satisfied:
0.7<f1/f<0.81.

13. The optical imaging lens as claimed in claim 11, wherein the focal length of the optical imaging lens is f, the focal length of the fifth lens element is f5, and the following condition is satisfied:
−0.45<f5/f<−0.2.

14. The optical imaging lens as claimed in claim 11, wherein a distance along the optical axis between the aperture stop and the image-side surface of the fifth lens element is SD, a distance along the optical axis between the object-side surface of the first lens element and the image-side surface of the fifth lens element is TD, and the following condition is satisfied:
0.89<SD/TD<1.05.

15. The optical imaging lens as claimed in claim 14, wherein a central thickness of the third lens element is CT3, a central thickness of the fourth lens element is CT4, and the following condition is satisfied:
1<CT4/CT3<1.4.

16. The optical imaging lens as claimed in claim 15, wherein an Abbe number of the first lens element is V1, an Abbe number of the second lens element is V2, an Abbe number of the third lens element is V3, an Abbe number of the fourth lens element is V4, an Abbe number of the fifth lens element is V5, and the following condition is satisfied:
−40<V2−Vn<−25, wherein n=1,3,4 and 5.

17. The optical imaging lens as claimed in claim 11, wherein a radius of curvature of the object-side surface of the fifth lens element is R9, a radius of curvature of the image-side surface of the fifth lens element is R10, and the following condition is satisfied:
0<(R9+R10)/(R9−R10)<0.5.

18. The optical imaging lens as claimed in claim 14, wherein the focal length of the optical imaging lens is f, the focal length of the fourth lens element is f4, and the following condition is satisfied:
0.25<f4/f<0.6.

19. The optical imaging lens as claimed in claim 18, wherein a maximal field of view of the optical imaging lens is FOV, and the following condition is satisfied:
72<FOV<84.
